(19) United States
(12) Patent Application Publication
(10) Pub. No.: US 2020/0177935 A1
(43) Pub. Date: Jun. 4, 2020

(54) SMART CAMERA, IMAGE PROCESSING APPARATUS, AND DATA COMMUNICATION METHOD

(71) Applicants: Kabushiki Kaisha Toshiba, Tokyo (JP); Toshiba Infrastructure Systems & Solutions Corporation, Kawasaki-shi (JP)

(72) Inventors: Daisuke Takasaki, Tokyo (JP); Shingo Yasunami, Inzai (JP); Shinichi Kurihara, Yokohama (JP)

(21) Appl. No.: 16/783,710

(22) Filed: Feb. 6, 2020

Related U.S. Application Data
(63) Continuation of application No. PCT/JP2018/030973, filed on Aug. 22, 2018.

(30) Foreign Application Priority Data
Aug. 22, 2017 (JP) 2017-159728
Aug. 30, 2017 (JP) 2017-166057

(51) Int. Cl. H04N 21/236; H04N 5/04; H04N 21/234

(52) U.S. Cl. CPC H04N 21/23614; H04N 21/23418; H04N 5/04

(57) ABSTRACT

According to an embodiment, a smart camera includes an image sensor, an encoder, a feature data generator, a synchronizer, a multiplexer, and a transmitter. The image sensor outputs a video signal. The encoder encodes the video signal to generate video data. The feature data generator generates feature data of the video signal. The synchronizer synchronizes the generated feature data with the video data. The multiplexer multiplexes the video data and the feature data synchronized with the video data into a transport stream. The transmitter transmits the transport stream to a communication network.

### CROSS-REFERENCE TO RELATED APPLICATIONS

This application is a Continuation Application of PCT Application No. PCT/JP2018/030973, filed Aug. 22, 2018 and based upon and claiming the benefit of priority from prior Japanese Patent Applications No. 2017-159728, filed Aug. 22, 2017 and No. 2017-166057, filed Aug. 30, 2017, the entire contents of all of which are incorporated herein by reference.

### FIELD

Embodiments described herein relate generally to a technique for a smart camera.

### BACKGROUND

Smart cameras are attracting attention. The smart camera includes an image sensor, a processor, and a communication function. A platform for utilizing video data as big data by linking a plurality of smart cameras with a cloud computing system (hereinafter, abbreviated as “cloud”) is also being developed. For example, performing fixed-point observation for disaster prevention, monitoring of traffic, monitoring of infrastructure such as roads and bridges, person searches or person tracking, and tracing of suspicious persons using video data are under consideration. In order to realize such a solution, it is important to obtain image analysis information by analyzing a video signal, video data (video stream data) or video stream with various algorithms.

Analysis of the video signal requires not only the video signal itself but also metadata (e.g., capturing date/time, resolution, camera position, camera directivity direction, etc.) accompanying the video signal. New image analysis information may be calculated using the image analysis information and the metadata. Image analysis information obtained by analyzing a video signal and metadata accompanying the video signal are collectively referred to as “feature data.” That is, the feature data includes at least one of the image analysis information and the metadata. The video data can be understood as digital data obtained by encoding the video signal.

In conventional techniques, in order to transmit the feature data, it is necessary to construct a system which differs from a collection system of video data, which is inefficient. Inability to synchronize the video signal and the feature data is a particular problem, and it has been difficult to perform analysis by combining both data on the cloud side. On the video data-use side, the ability to acquire feature data synchronized with the video signal is desired.

### BRIEF DESCRIPTION OF THE DRAWINGS

FIG. 1 is a system diagram showing an example of a surveillance camera system according to an embodiment;

FIG. 2 is a block diagram showing an example of cameras C1 to Cn;

FIG. 3 is a block diagram showing an example of an image processing apparatus 200;

FIG. 4 is a diagram showing an example of functional blocks of the cameras C1 to Cn;

FIG. 5 is a diagram showing an example of functional blocks of a camera information generating function 1a shown in FIG. 4;

FIG. 6 is a diagram showing an example of feature data parameters;

FIG. 7 is a diagram showing an example of functional blocks of a detection information generating function 2e shown in FIG. 4;

FIG. 8 is a diagram showing an example of feature data;

FIG. 9 is a diagram showing an example of a process for generating content with feature data;

FIG. 10 is a diagram showing a TS basic system of a transport stream;

FIG. 11 is a diagram showing an example of a transport stream including feature data that is synchronized and multiplexed;

FIG. 12 is a diagram showing an example of feature data elementary regarding point cloud data;

FIG. 13 is a diagram showing an example of functional blocks of the image processing apparatus 200;

FIG. 14 is a flowchart showing an example of a processing procedure of the cameras C1 to Cn according to a first embodiment;

FIG. 15 is a flowchart showing an example of a processing procedure of the image processing apparatus 200 according to the first embodiment;

FIG. 16 is a diagram showing another example of functional blocks of the cameras C1 to Cn;

FIG. 17 is a diagram showing another example of feature data;

FIG. 18 is a diagram showing another example of functional blocks of the image processing apparatus 200;

FIG. 19 is a flowchart showing an example of a processing procedure of the cameras C1 to Cn according to a second embodiment;

FIG. 20 is a flowchart showing an example of a processing procedure of the image processing apparatus 200 according to the second embodiment;

FIG. 21 is a flowchart showing another example of a processing procedure of the cameras C1 to Cn according to the second embodiment;

FIG. 22 is a flowchart showing another example of a processing procedure of the cameras C1 to Cn according to the second embodiment;

FIG. 23 is a diagram showing an example of a data flow related to person tracking in the surveillance camera system according to the embodiment;

FIG. 24 is a diagram showing another example of functional blocks of the cameras C1 to Cn shown in FIG. 1;

FIG. 25 is a diagram showing another example of functional blocks of the image processing apparatus 200;

FIG. 26 is a diagram showing an example of information exchanged between the camera and the image processing apparatus;

FIG. 27 is a flowchart showing an example of a processing procedure of a camera according to a third embodiment;

FIG. 28 is a diagram showing another example of feature data parameters;

FIG. 29 is a diagram for explaining a working effect in the embodiment;

FIG. 30 is a system diagram showing another example of a surveillance camera system; and

FIG. 31 is a system diagram showing another example of a surveillance camera system.

### DETAILED DESCRIPTION

In general, according to an embodiment, a smart camera includes an image sensor, an encoder, a feature data generator, a synchronizer, a multiplexer, and a transmitter. The image sensor outputs a video signal. The encoder encodes the video signal to generate video data. The feature data generator generates feature data of the video signal. The synchronizer synchronizes the generated feature data with the video data. The multiplexer multiplexes the video data and the feature data synchronized with the video data into a transport stream. The transmitter transmits the transport stream to a communication network.

Embodiments of the present invention will be described with reference to the drawings. In this specification, an image is understood to be a still image or an image for one frame constituting a moving image. A video is a set of a series of images, and can be understood as a moving image.

In recent years, smartphones and in-vehicle cameras, etc. equipped with a plurality of cameras through downsizing and lower prices of sensor devices have been sold. Research has also been conducted on the generation of stereo images using a compound-eye camera and the generation of images with distance information (distance images). An array camera in which a plurality of camera devices are arranged in an array is also known. Furthermore, a multispectral camera (also referred to as a “hybrid camera”) in which a visible light camera, a near-infrared camera, and a far-infrared camera are installed on a common housing is also known. These next-generation cameras are expected to be applied to a remote monitoring system, etc. through their connection to a center device via a wired network or a wireless network.

It is rare to send video data of all the cameras of the array camera to the center device, and an image of any one of the cameras is often switched over and output. For example, for person detection, a fixed-point observation is performed with a visible light camera during the day, but the camera is switched over to an infrared camera at night. In this way, an occupied band required for transporting a stream including a video is minimized.

However, when the video is switched over, processing on the transport stream-reception side cannot keep pace, and a part of the time-series image analysis data may be lost. In terms of technique, this is called “occurrence of discontinuity in image processing.” For example, if a color video suddenly switches over to a monochrome video, it is difficult for the center device in turn to continue the image processing even though it has acquired a video with the same field of view. There are various factors that cause discontinuity, such as difference in color tone, difference in wavelength, difference in contrast, focus deviation, difference in screen size, and difference in field angle between cameras. There is a concern that image processing may be reset if discontinuity becomes significant.

Maintaining the continuity of image processing before and after switchover (frame switchover) of a video is difficult. The situation is the same even in a system in which a common visual field is observed by a plurality of monocular cameras.

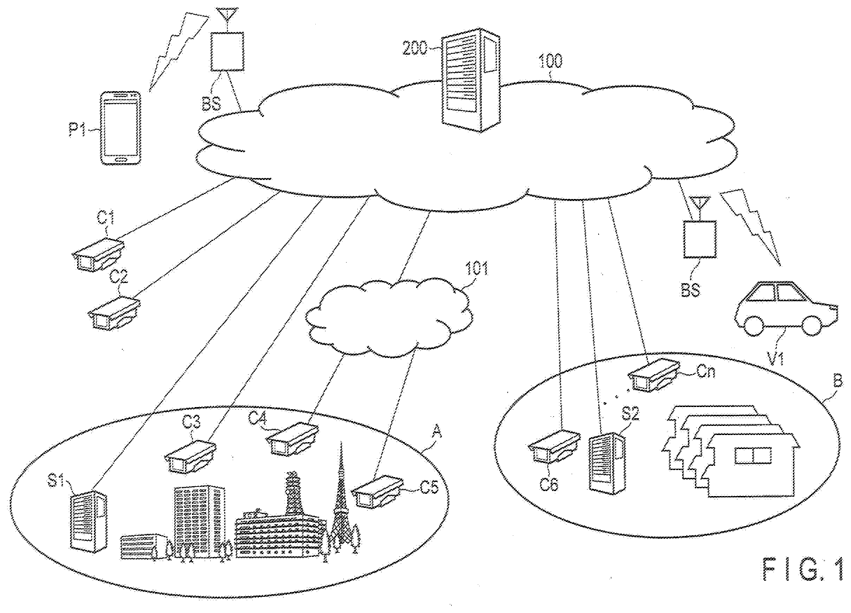

FIG. 1 is a system diagram showing an example of a surveillance camera system according to an embodiment. The system shown in FIG. 1 includes a plurality of cameras C1 to Cn as smart cameras and an image processing apparatus 200 provided in a cloud 100. The cameras C1 to Cn are connected to the cloud 100.

The cameras C1 to Cn are installed in different places. For example, the cameras C3 to C5 are arranged in an area A including a street where high-rise office buildings are lined up; the cameras C6 to Cn are arranged in an area B including a suburban residential area; and the cameras C1 and C2 are arranged at locations other than the areas A and B. Each of the cameras C1 to Cn has an optical system (including a lens and an imaging device). Each of the cameras C1 to Cn senses a video captured in the field of view of the optical system at each location, and generates video data.

The image processing apparatus 200 is connected to the cameras C1 to Cn, a base station BS of a mobile communication system, or a database, etc. via a communication network. As a communication network protocol, for example, TCP/IP (Transmission Control Protocol/Internet Protocol) can be used. A relay network 101 may be interposed between the cameras and the cloud 100.

The image processing apparatus 200 collects the video stream transmitted from each of the cameras C1 to Cn as a transport stream. The image processing apparatus 200 performs image processing, e.g. shading, filtering, or outline extraction, on the collected video data.

A vehicle V1 or a cellular phone P1 can also access the cloud 100 via the base station BS. An in-vehicle camera of the vehicle V1 and a camera of the cellular phone P1 can also operate as smart cameras.

In the areas A and B, for example, edge servers S1 and S2 are installed, respectively. The edge server S1 requests data according to characteristics of the area A (e.g., a large daytime population) from the cloud 100, and realizes service provision according to the acquired data and construction of a platform for providing the service. Further, the edge server S1 may function as resources such as a high-speed arithmetic processing function and a large-capacitance storage, for allowing a user to use the acquired data.

The edge server S2 requests data pertaining to the characteristics (e.g., the large number of children or schools) of the area B from the cloud 100, and realizes service provision according to the acquired data and construction of a platform for providing the service. The edge server S2 may function as the resource for allowing the user to use the acquired data.

In addition, a usage form of a cloud computing system is broadly classified into SaaS (Software as a Service) that provides an application as a service, PaaS (Platform as a Service) that provides a platform for operating an application as a service, and IaaS (Infrastructure as a Service) that provides resources such as a high-speed arithmetic processing function and a large-capacitance storage as a service. The cloud 100 is applicable to all the forms.

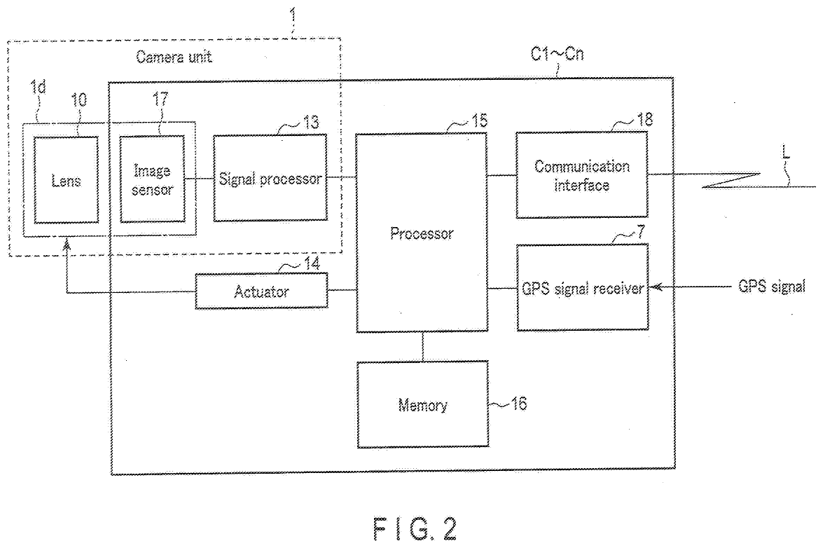

FIG. 2 is a block diagram showing an example of the camera C1. The cameras C2 to Cn have the same configuration. The camera C1 includes a camera unit 1, an actuator 14, a processor 15, a memory 16, a communication interface 18, and a GPS signal receiver 7.

The camera unit 1 includes an imaging unit 1d as an optical system, and a signal processor 13. The imaging unit 1d includes a lens 10 and an image sensor 17 that captures a field of view of the lens 10 and outputs a video signal. The image sensor 17 is a CMOS (complementary metal oxide semiconductor) sensor, for example, and generates a video signal with a frame rate of 30 frames per second, for example. The signal processor 13 performs digital arithmetic processing such as encoding on the video signal output from the image sensor 17 of the imaging unit 1d. The imaging unit 1d includes a collimator for adjusting a light amount, a motor mechanism for changing an imaging direction, etc.

The actuator 14 drives each mechanism based on the control of the processor, and adjusts the light amount upon the image sensor 17 and adjusts an imaging direction.

The processor 15 comprehensively controls an operation of the camera C1 based on a program stored in the memory 16. The processor 15 includes, for example, a multi-core CPU (Central Processing Unit), and is an LSI (Large Scale Integration) tuned to execute image processing at high speed. The processor 15 can be configured by an PPGA (Field Programmable Gate Array), etc. An MPU (Micro Processing Unit) is also a kind of processor.

The memory 16 is a semiconductor memory such as Synchronous Dynamic RAM (SDRAM), or a nonvolatile memory such as Erasable Programmable ROM (EPROM) or Electrically Erasable Programmable ROM, and stores a program for causing the processor 15 to execute various functions according to the embodiment, video data, etc. That is, the processor 15 loads and executes a program stored in the memory 16 to realize various functions to be described in the embodiments.

The GPS signal receiver 7 receives a positioning signal transmitted from a GPS (Global Positioning System) satellite, and performs a positioning process based on positioning signals from a plurality of satellites. Location information of the camera C1 and time information are obtained by the positioning process. In particular, location information is important when using a moving camera such as a cellular phone or an in-vehicle camera. The location information and the time information are stored in the memory 16. The communication interface 18 is connected to the cloud 100 via a dedicated line L, and mediates unidirectional or bidirectional data communication.

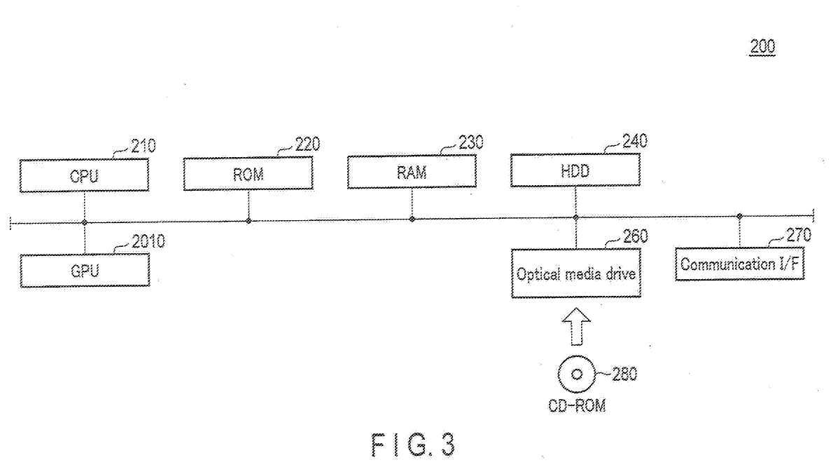

FIG. 3 is a block diagram showing an example of the image processing apparatus 200. The image processing apparatus 200 is a computer including a CPU 210, and includes a ROM (Read Only Memory) 220, a RAM (Random Access Memory) 230, a hard disk drive (HDD) 240, an optical media drive 260, a communication interface (I/P) 270, and a GPU (Graphics Processing Unit) 2010.

The CPU 210 executes an OS (Operating System) and various programs. The ROM 220 stores basic programs such as BIOS (Basic Input Output System) and UEFI (Unified Extensible Firmware Interface), and various setting data, etc. The RAM 230 temporarily stores programs and data loaded from the HDD 240. The HDD 240 stores the programs executed by the CPU 210 and data.

The optical media drive 260 reads digital data recorded on a recording medium such as a CD-ROM 280. Various programs executed by the image processing apparatus 200 can be recorded, for example, on the CD-ROM 280 and distributed. The programs stored in this CD-ROM 280 can be read by the optical media drive 260, and installed in the HDD 240. The latest program can be downloaded from the cloud 100 to update an already-installed program.

The communication interface 270 is connected to the cloud 100 and communicates with the cameras C1 to Cn and other servers and databases of the cloud 100.

The GPU 2010 is a processor with particularly enhanced functions for image processing, and can perform arithmetic processing such as a product-sum operation, a convolution operation, and a 3D (three-dimensional) reconstruction at high speed. Next, a plurality of embodiments will be described based on the above configuration.

### First Embodiment

### Deterioration Diagnosis of Social Infrastructure Using Point Cloud Data

In the first embodiment, as an example of an application realized by linking the cameras C1 to Cn and the cloud 100, a social infrastructure deterioration diagnosis based on point cloud data will be described. A point cloud is a set of points distinguished by position coordinates, and has been applied in various fields In recent years. For example, when a time series of point cloud data composed of position coordinates of each point on the surface of a structure is calculated, a temporal change in shape of the structure can be obtained.

In the embodiment, the point cloud data can be understood as a set having coordinates as elements. A coordinate is a set of numbers for specifying the position of a point. For example, a set having three-dimensional coordinates represented by (x, y, z) as elements is point cloud data. A set of four-dimensional coordinates (x, y, z, t) obtained by adding one dimension of time to the three-dimensional coordinates can also be understood as point cloud data.

Furthermore, information combining coordinates and attribute information of a point corresponding to the coordinates can be considered as a form of the point cloud data. For example, color information including R (red), G (Green), and B (Blue) is an example of the attribute information. Accordingly, if data represented by a vector (x, y, z, R, G, B) is used, a color for each coordinate can be managed. Data of such a structure is convenient for monitoring, for example, deterioration with age of a building wall surface color, etc.

Not only point cloud data but also three-dimensional CAD (Computer Aided Design) data, altitude data, map data, topographic data, distance data, etc. can be expressed as data consisting of a set of coordinates. Furthermore, data representing three-dimensional spatial information and location information, and information similar thereto, and data that can be converted into these data, can also be understood as examples of point cloud data.

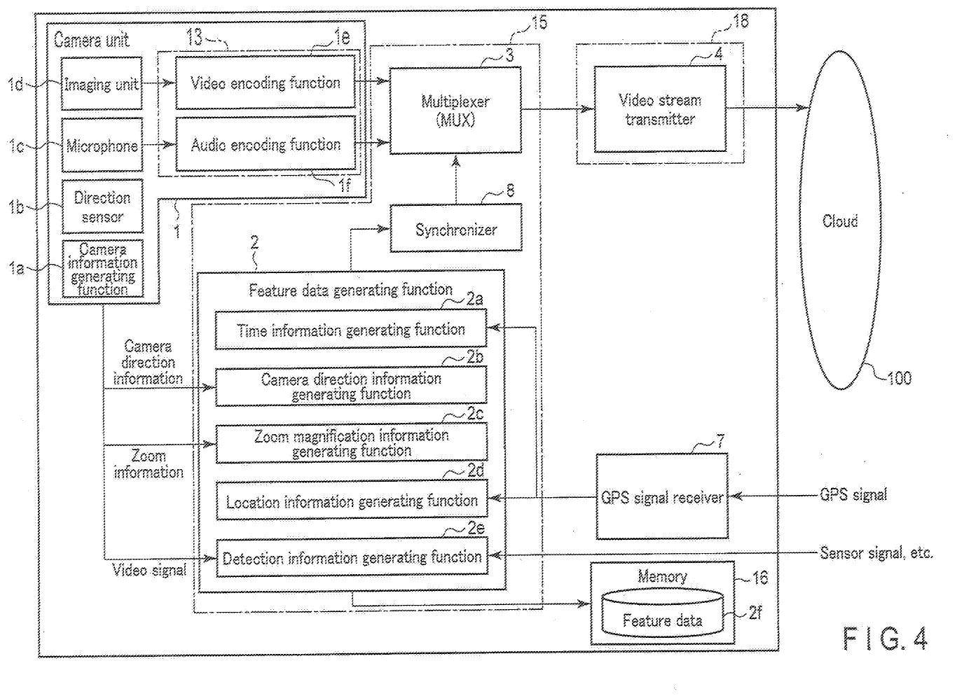

FIG. 4 is a diagram showing an example of functional blocks implemented on hardware of the camera C1 shown in FIG. 2. The cameras C2 to Cn also have similar functional blocks. In addition to the camera unit 1, the GPS signal receiver 7, and the memory 16, the camera C1 includes a feature data generating function 2, a synchronizer 8, a multiplexer (MUX) 3, and a video stream transmitter 4.

The camera unit 1 includes an imaging unit 1d, a microphone 1c, a camera information generating function 1a, a direction sensor (for example, an azimuth sensor, a gyro sensor or a position sensor using potentiometer, etc.) 1b, a video encoding function 1e, and an audio encoding function 1f. Among them, the video encoding function 1e and the audio encoding function 1f can be implemented as a function of the signal processor 13.

The video encoding function 1e as an encoder encodes a video signal including video information from the imaging unit 1d according to, for example, ARIB STD-B32 to generate video data. This video data is input to the multiplexer 3.

The microphone 1c collects sound around the camera C1, and outputs an audio signal including audio information. The audio encoding function 1f encodes this audio signal according to, for example, ARIB STD-B32 to generate audio data. This audio data is input to the multiplexer 3.

The direction sensor 1b is a geomagnetic sensor using, for example, a Hall element, and outputs a directivity direction with respect to a three-dimensional axis (X axis, Y axis, Z axis) of the imaging unit 1d. The output of the direction sensor 1b is send to the feature data generating function 2 as camera direction information. The camera direction information may include tilt angle information of the camera body, etc.

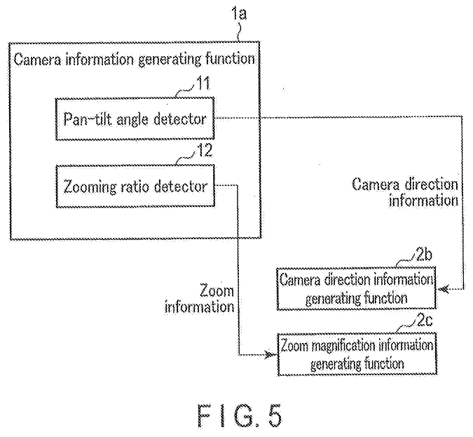

As shown in FIG. 5, for example, the camera information generating function 1a includes a pan-tilt angle detector 11 and a zooming ratio detector 12. The pan-tilt angle detector 11 detects a tilt angle of the camera C1 with a rotary encoder, etc., and sends the camera direction information to a camera direction information generating function 2b of the feature data generating function 2 (FIG. 4). The zooming ratio detector 12 detects a zooming ratio related to the lens 10 of the imaging unit 1d, and sends the zoom information to a zoom magnification information generating function 2c of the feature data generating function 2. Furthermore, information such as a throttle opening of the camera C1 arid whether or not a target is captured within the field of view can be output from the camera information generating function 1a.

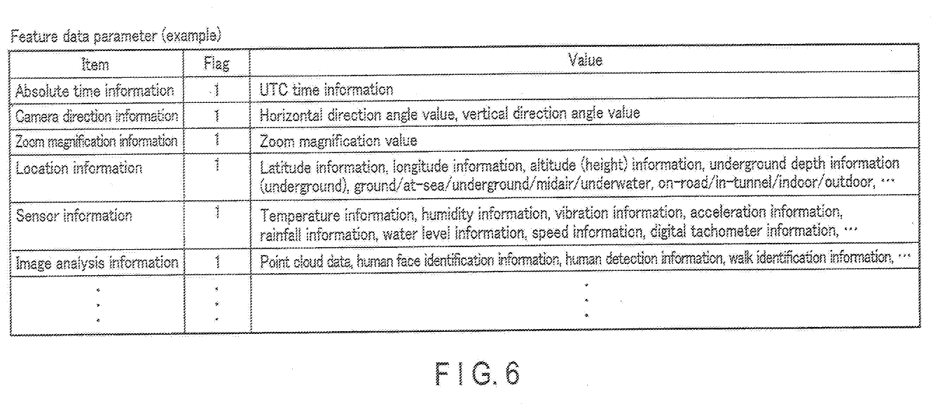

The feature data generating function 2 in FIG. 4 generates feature data indicating features of a video signal. The feature data includes items such as those shown in feature data parameters of FIG. 6. In FIG. 6, the feature data parameters include items such as absolute time information, camera direction information, zoom magnification information, location information, and sensor information. These can be understood as metadata of the video signal.

Furthermore, the feature data parameters include an item of image analysis information. The image analysis information is information such as point cloud data of a structure, human face identification information, human detection information, and walk identification information, obtained by analyzing the video signal. For example, a Haar-Like feature value that is also used in OpenCV (Open Source Computer Vision Library) can be raised as an example of the face identification information. In addition, image analysis information such as a histograms of oriented gradients (HOG) feature value and a co-occurrence HOG (Co-HOG) feature value are known.

In FIG. 4, the feature data generating function 2 includes a time information generating function 2a, the camera direction information generating function 2b, the zoom magnification information generating function 2c, a location information generating function 2d, and a detection information generating function 2e.

The time information generating function 2a acquires time information from the GPS signal receiver 7, and generates UTC (Universal Time Co-ordinated) time information (FIG. 6) as absolute time information. The camera direction information generating function 2b generates, from the camera information acquired from the camera information generating function 1a, a horizontal direction angle value, a vertical direction angle value (FIG. 6), etc. of the directivity direction of the imaging unit 1d as camera direction information.

The zoom magnification information generating function 2c generates zoom magnification information such as a zoom magnification value from the zoom information acquired from the camera information generating function 1a. The location information generating function 2d generates location information such as latitude information, longitude information, and altitude (height) information based on the positioning data acquired from the GPS signal receiver 7.

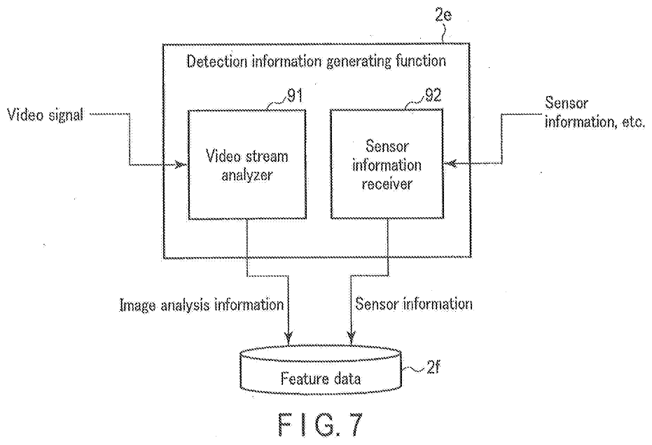

As shown in FIG. 7, for example, the detection information generating function 2e includes a video stream analyzer 91 and a sensor information receiver 92. The video stream analyzer 91 as an analyzer analyzes a video signal from the camera unit 1, and generates image analysis information based on this video signal. The sensor information receiver 92 acquires sensor information, etc. from various sensors provided in the camera C1, and generates sensor information such as temperature information, humidity information, . . . , and digital tachometer information (an in-vehicle camera, etc.).

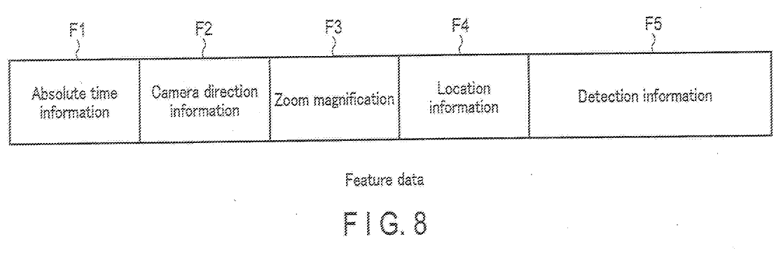

The memory 16 stores a feature data storage 2f in a storage area thereof. The feature data storage 2f stores feature data as shown in FIG. 8, for example. In FIG. 8, the feature data includes detection information F5 in addition to sensor information such as absolute time information F1, camera direction information F2, zoom magnification F3, and location information F4. Image analysis information can be included in the detection information F5.

Returning to FIG. 4, the description will be continued. The synchronizer 8 synchronizes the feature data sent from the feature data generating function 2 with the video data from the camera unit 1. That is, the synchronizer 8 matches a time stamp of the feature data with a time stamp (e.g., absolute time) of an image frame using a buffer memory, etc. As a result, a time series of the video data and that of the feature data are aligned.

The multiplexer 3, as a multiplexer, multiplexes the video data and the feature data synchronized with the video data into, for example, a transport stream of an MPEG-2 (Moving Picture Experts Group-2) system. That is, the multiplexer 3 multiplexes the feature data synchronized with time into the transport stream.

If MPEG-2 Systems are used, a PES header option according to ITU-T Recommendation H.222. can be used. As a stream identifier in a PES packet, at least one of the auxiliary stream (0xF9), metadata stream (0xFC), extended stream ID (0xFD), and undefined (0xFC) , disclosed in Non-Patent Document 2can be used.

The multiplexer 3 multiplexes the feature data in a preset time period into the transport stream. The preset time period is, for example, a daytime period when the amount of human activity is high, or a weekday when the working population increases. In addition, the feature data may be generated and multiplexed only when a moving object is captured in the field of view. By doing so, a transmission band can be saved.

The video stream transmitter 4 as a transmitter transmits a transport stream (TS) output from the multiplexer 3 to the cloud 100 via a communication network.

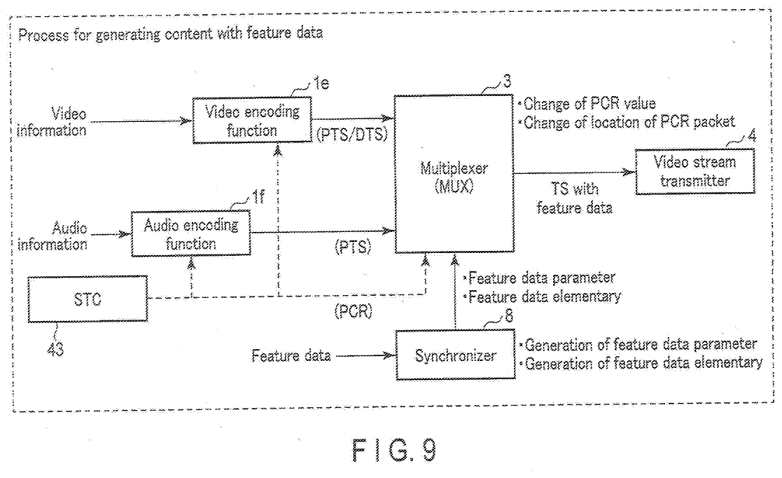

FIG. 9 is a diagram showing an example of a process for generating a transport stream including feature data. This process is referred to as a “process for generating content with feature data.” The process for generating content with feature data is realized by the video encoding function 1e, the audio encoding function 1f, the multiplexer 3, the synchronizer 8, and the video stream transmitter 4 functioning in cooperation.

The video encoding function 1e, the audio encoding function 1f, the multiplexer 3, the synchronizer 8, and the video stream transmitter 4 can realize their functions as processes generated in a process where the processor 15 of FIG. 2 executes arithmetic processing based on the programs stored in the memory 16. That is, the process for generating content with feature data in FIG. 9 is one of the processing functions realized by an image encoding process, an audio encoding process, a multiplexing process, a synchronization process, and a video stream transmission process performing inter-process communication with one another and exchanging data.

In FIG. 9, the video signal is compression encoded by the video encoding function 1e, and sent to the multiplexer 3. The audio signal is compression encoded by the audio encoding function 1f, and sent to the multiplexer 3. The multiplexer 3 converts the compression-encoded video signal and audio signal respectively into data signals having a packet structure of, for example, MPEG2-TS format, and sequentially arranges a video packet and an audio packet to multiplex them.

A transport stream (TS) with feature data generated thereby is send to the video stream transmitter 4. At this time, the video encoding function 1e receives an STC (System Time Clock) from an STC generator 43, generates a PTS (Presentation Time Stamp)/DTS (Decoding Time Stamp) from this STC, and embeds it in image encoded data. The audio encoding function 1f also acquires an STC, generates a PTS from the STC, and embeds the PTS in audio encoded data. Furthermore, the multiplexer 3 also receives an STC, and performs insertion of a PCR (Program Clock Reference) based on this STC, change of a PCR value, change of a location of a PCR packet, etc.

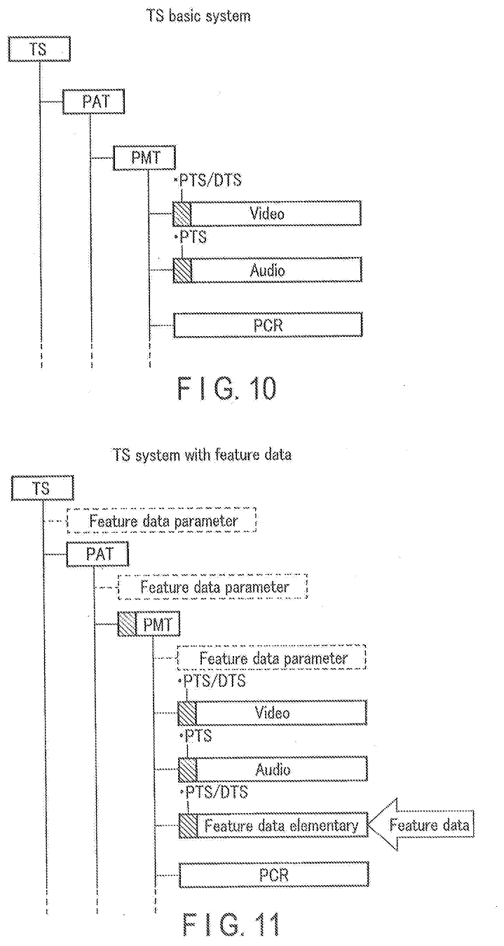

By the process so far, a TS basic system of a transport stream as shown in FIG. 10 is obtained. This TS basic system has a hierarchical structure of a TS (Transport Stream), a PAT (Program Association Table), and a FMT (Program Map Table), and PBS (Packetized Elementary Stream) packets such as video (Video), audio (Audio), and PCR are arranged under the PMT. The FTS/DTS is inserted into a header of the video packet, and the PTS is inserted into a header of the audio packet.

Furthermore, in FIG. 9, the synchronizer 8 generates the feature data parameters and a feature data elementary, and sends them to the multiplexer 3. The multiplexer 3 embeds the feature data using the MPEG2-TS structure of the TS basic system.

As shown in FIG. 11, the multiplexer 3 arranges the feature data parameter at any position (under TS, PAT, or PMT) in the TS basic system. In addition, the multiplexer 3 arranges the feature data elementary to a header of which the PTS/DTS is added under the PMT. At this time, for example, an identifier such as a stream type or an elementary PID may be inserted into a header of the PMT including the feature data elementary. The feature data parameter may be included in the feature data elementary.

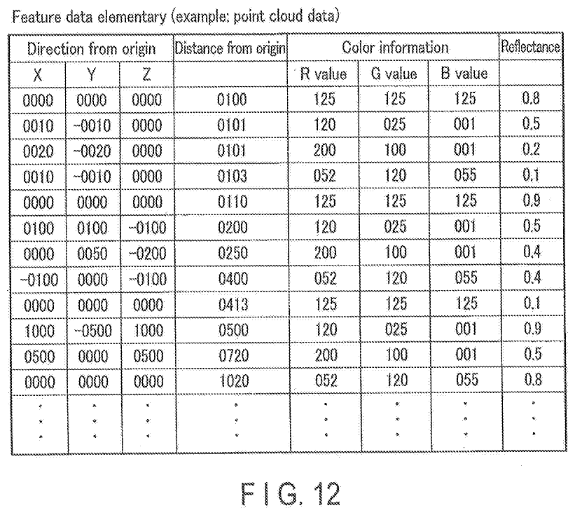

FIG. 12 is a diagram showing an example of a feature data elementary related to point cloud data. The point cloud data is represented by a data structure including a direction (X, Y, Z) from an origin (e.g., the position of the camera), a distance from the origin, color information (R, G, B values), and reflectance. The feature data elementary is generated by digitizing these items. When using an in-vehicle camera, an origin can be calculated based on location information acquired by a GPS.

In the foregoing, an example of functional blocks implemented on the cameras C1 to Cn in the first embodiment, has been described. More specifically, for example, the video stream transmitter 4 in FIG. 4 is implemented as a function of the communication interface 18 in FIG. 2. In addition, each function of the multiplexer 3, the synchronizer 8, the feature data generating function 2, the time information generating function 2a, the camera direction information generating function 2b, the zoom magnification information generating function 2c, the location information generating function 2d, and the detection information generating function 2e in FIG. 4, is realized via the loading of a program stored in the memory 16 of FIG. 2 into a register of the processor 15 and execution of the arithmetic processing by the processor 15 according to a process generated as the program progresses. That is, the memory 16 stores a multiplexing program, a synchronization program, a feature data generation program, a time information generation program, a camera direction information generation program, a zoom magnification information generation program, a location information generation program, and a detection information generation program. Next, a configuration of the image processing apparatus 200 of the cloud 100 will be described.

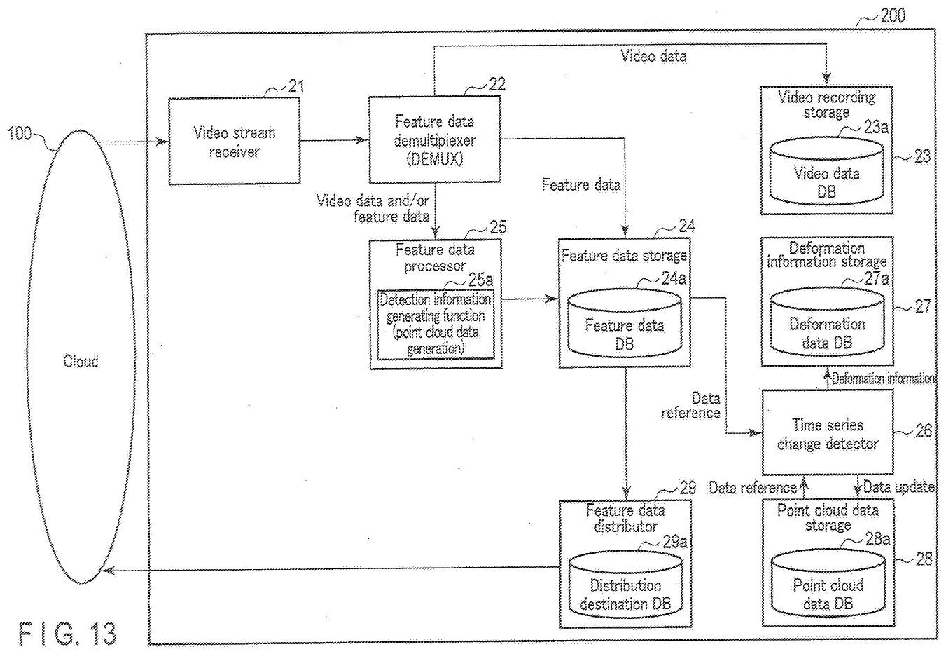

FIG. 13 is a diagram showing an example of functional blocks implemented in the hardware of the image processing apparatus 200 shown in FIG. 3. The image processing apparatus 200 includes a video stream receiver 21, a feature data demultiplexer (DEMUX) 22, a video recording storage 23, a video data database (DB) 23a, a feature data storage 24, and a feature data database (DB) 24a, a feature data processor 25, a detection information generating function 25a, a time series change detector 26, a deformation information storage 27, a deformation data database (DB) 27a, a point cloud data storage 28, and point cloud data database (DB) 28a.

The video stream receiver 21 receives the transport streams from the cameras C1 to Cn via the communication network of the cloud 100. The received transport streams are sent to the feature data demultiplexer 22. The feature data demultiplexer 22 demultiplexes the video data and the feature data from the transport streams. The video data is stored in the video data database (DB) 23a of the video recording storage 23. The feature data is stored in the feature data database (DB) 24a of the feature data storage 24.

In addition, at least one of the video data and the feature data is sent to the feature data processor 25. The feature data processor 25 includes the detection information generating function 25a. The detection information generating function 25a processes the feature data respectively transmitted from the cameras C1 to Cn, and generates the point cloud data as shown in FIG. 12. The generated point cloud data is sent to the feature data storage 24, arid stored in the feature data DB 24a in association with the feature data.

The stored feature data is read in response to a request from a feature data distributor 29, and distributed to destination information of a distribution destination recorded in a distribution destination database. The destination information is, for example, an IP (Internet Protocol) address. If an IP address conforming to IPv6 (IP version 6) is used, a system having a high compatibility with IoT (Internet of Things) can be constructed, but an IP address conforming to IPv4 (IP version 4) can also be used.

The time series change detector 26 compares the point cloud data stored in the feature data DB with the past point cloud data (stored in the point cloud data database (DB) 28a of the point cloud data storage 28) to detect a time-series change of the point cloud data. This time-series change of the point cloud data is sent as deformation information to the deformation information storage 27, and stored in the deformation data database (DB) 27a.

Each processing function of the video stream receiver 21, the feature data demultiplexer 22, the feature data processor 25, the detection information generating function 25a, and the time series change detector 26, the point cloud data storage 28, and the feature data distributor 29 shown in FIG. 13, is realized by, after a program stored in the HDD 240 in FIG. 3 is loaded into the RAM 230, executing arithmetic processing by the CPU 210 according to a process generated as the program progresses. That is, the HDD 240 stores a video stream reception program, a feature data demultiplexing program, a feature data processing program, a detection information generation program, a time series change detection program, a point cloud data management program, and a feature data distribution program.

Furthermore, the video recording storage 23, the feature data storage 24, and the deformation information storage 27 shown in FIG. 13 are storage areas provided in, for example, the HDD 240 of FIG. 3, and the video data DB 23a, the feature data DB 24a, the deformation data DB 27a, the point cloud data DB 28a, and distribution destination DB 29a are stored in storage areas thereof. Next, a working effect in the above configuration will be described.

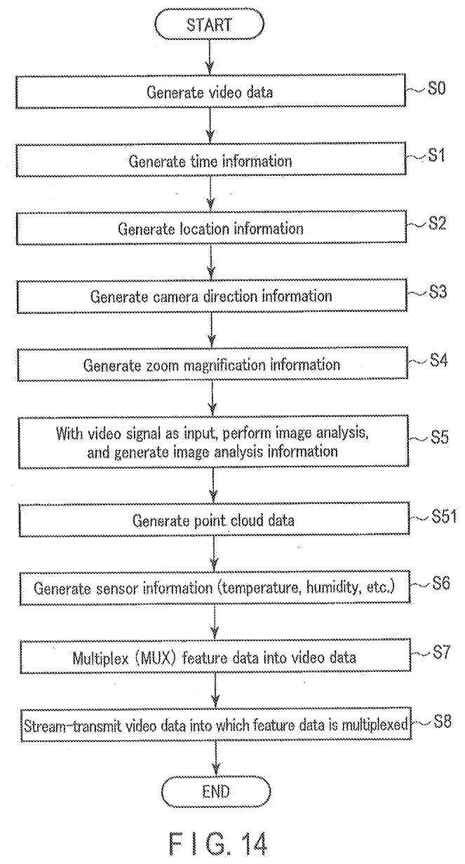

FIG. 14 is a flowchart showing an example of a processing procedure of the cameras C1 to Cn in the first embodiment. Herein, description will be made mainly with reference to the camera C1, but the cameras C2 to Cn operate in the same manner.

In FIG. 14, the camera C1 encodes a video signal to generate video data (step S0), and continuously executes time information generation (step S1), location information generation (step S2), camera direction information generation (step S3), and zoom magnification information generation (step S4). The camera C1 analyzes the video signal to generate image analysis information (step S5). Furthermore, the point cloud data may be generated by integrating this image analysis information with the time information, the location information, the camera direction information, and the zoom magnification information (sensor fusion) (step S51).

Furthermore, the camera C1 appropriately acquires information from other sensors, and generates sensor information such as temperature information and humidity information (step S6). Next, the camera C1 generates feature data from this information, multiplexes the feature data into the video data (step S7), and stream-transmits the generated video data toward the image processing apparatus 200 (step S8).

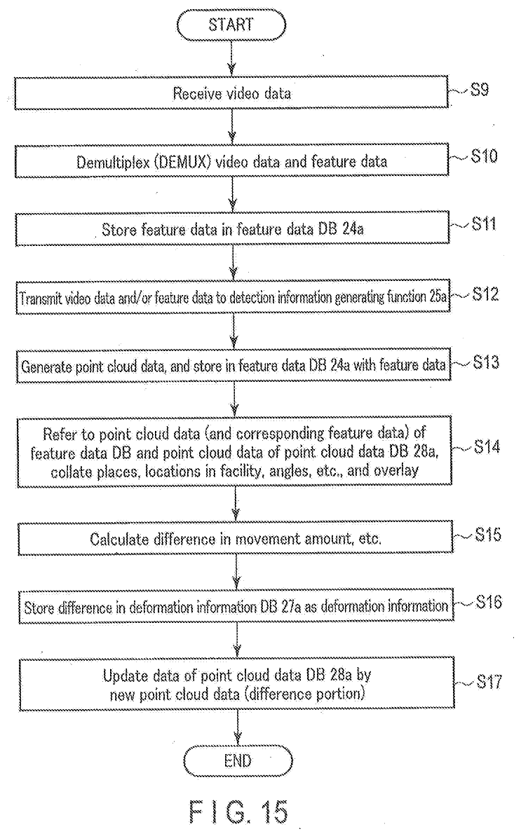

FIG. 15 is a flowchart showing an example of a processing procedure of the image processing apparatus 200 according to the first embodiment. When receiving the video data stream-transmitted from the camera C1 (step S9), the image processing apparatus 200 demultiplexes (DEMUX) the video data and the feature data from the received transport stream (step S10). The image processing apparatus 200 stores the demultiplexed feature data in the feature data (DB) 24a (step S11), and then transmits the video data and/or the feature data to the detection information generating function 25a (step S12).

Next, the image processing apparatus 200 generates point cloud data using the feature data, and stores the point cloud data and the feature data in the feature data DB 24a (step S13). Subsequently, the image processing apparatus 200 refers to the point cloud data stored in the feature data DB 24a and the feature data corresponding thereto, and the point cloud data of the point cloud data DB 28a. The image processing apparatus 200 then collates places, locations in the facility, angles, etc., and overlays the point cloud data (step S14).

Based on an overlay result, the image processing apparatus 200 calculates a difference in movement amount, etc. of each point (step S15), and stores this difference as deformation information in the deformation data DB 27a (step S16). Furthermore, the image processing apparatus 200 sends new point cloud data corresponding to a difference portion to the point cloud data storage 28, and updates the point cloud data DB 28a (step S17).

As described above, in the first embodiment, the video signals are individually acquired by the cameras C1 to Cn connected to the network and analyzed to generate the feature data. Then, the video data and feature data obtained by encoding the video signal are multiplexed into a transport stream while maintaining mutual synchronism, and transmitted from each of the cameras C1 to Cn to the cloud 100. That is, the video signal and the feature data related to this video signal are synchronously multiplexed into a common transport stream of, for example, MPEG-2 Systems, and transported to the image processing apparatus 200. Thereby, the image processing apparatus 200 can acquire the feature data synchronized with the video signal only by demultiplexing the video data and the feature data from the transport stream.

For example, an image file format called Exif (Exchangeable image file format) is known. However, it is a method of embedding photograph date and time in a still image, and is not suitable for handling feature data of a video and also for a precise synchronization. DICOM (Digital Imaging and Communication in Medicine) known as a medical image format is also a format in which examination information, etc. is described in tag information of a still image, and is thus not suitable for handling feature data based on a video.

In contrast, according to the first embodiment, the feature data including image analysis information obtained by analyzing video data and metadata of the video data can be synchronized with the video data and multiplexed into a transport stream. That is, a video signal and feature data can be synchronized and transported.

In addition, since the image processing apparatus that has received the transport stream can acquire the feature data synchronized with the video data, it can generate highly accurate point cloud data based on accurate location data. This makes it possible to diagnose a deterioration situation of social infrastructure such as roads and facilities with high accuracy.

### Second Embodiment

### Person Tracking

In the second embodiment, person tracking will be described as another example of an application realized by linking the cameras C1 to Cn with the cloud 100. The person tracking is a solution for tracing a movement locus of a specific individual based on video data, and in recent years, the demand has been increasing.

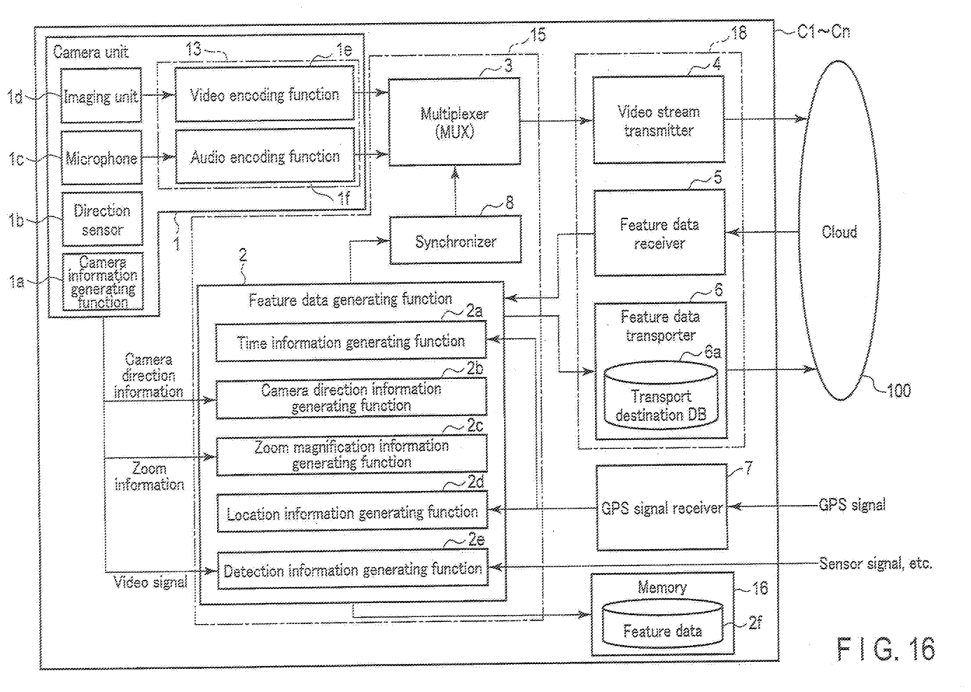

FIG. 16 is a diagram showing another example of functional blocks of the cameras C1 to Cn. In FIG. 16, the portions common to FIG. 4 are denoted with the same reference signs, and only different portions will be described herein. The camera C1 shown in FIG. 16 further includes a feature data receiver 5 and a feature data transporter 6. The feature data transporter 6 stores a transport destination database (DB) 6a.

The feature data receiver 5 receives feature data transported from another smart camera. The received feature data is recorded in the feature data DB 2f. The feature data transporter 6 transports the feature data generated by the feature data generating function 2 toward a partner registered in advance. Destination information of a destination to which the feature data is to be transported is recorded in the transport destination database (DB) 6a in the form of an IP address, etc. Note that the video stream transmitter 4, the feature data receiver 5, the feature data transporter 6, and the transport destination DB 6a can be implemented as functions of the communication interface 18 of FIG. 2.

In the first embodiment, it has been described that the feature data is multiplexed into the transport stream and transported. The second embodiment discloses a mode in which feature data is exchanged between devices, for example, in the form of IP packets.

For example, feature data can be transported by adding the feature data to image data multiplexed by a lossless compression method represented by JPEG (Joint Picture Experts Group) 2000. When JPEG2000 is used, the feature data is processed to conform to ITU-T Recommendation T.801, T.802, or T.813, etc. Such feature data may be inserted in a data field such as an XML box or a UUID box of JPEG2000.

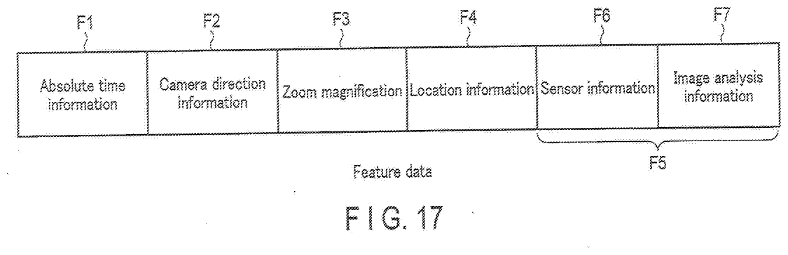

FIG. 17 is a diagram showing another example of feature data. In FIG. 17, the feature data includes the detection information F5 in addition to the absolute time information F1, the camera direction information F2, the zoom magnification F3, and the location information F4 Sensing data F6 and image analysis information F7 can be applied to the detection information F5.

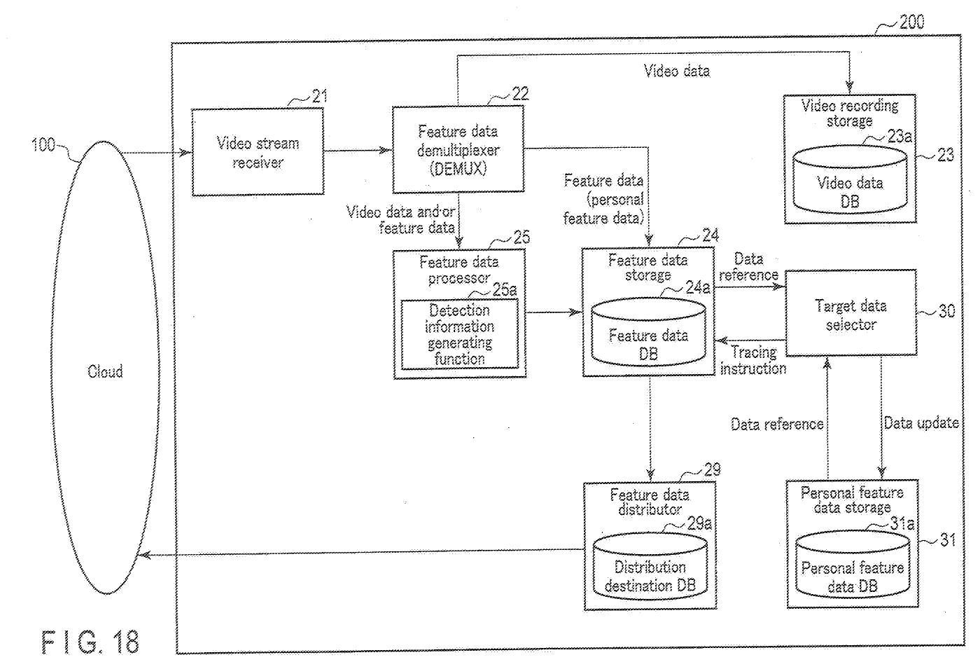

FIG. 18 is a diagram showing another example of functional blocks of the image processing apparatus 200. In FIG. 18, the portions common to FIG. 13 are denoted with the same reference signs, and only different portions will be described herein.

The image processing apparatus 200 shown in FIG. 18 further includes the feature data distributor 29, a target data selector 30, and a personal feature data storage 31. The personal feature data storage 31 stores a personal feature data database (DB) 31a. The personal feature data DB 31a is a database in which, for example, personal feature data indicating a feature of a person serving as a tracing target is recorded.

Among them, the target data selector 30 collates the personal feature data demultiplexed from the transport stream with the personal feature data in the personal feature data DB 31a. If it is determined based on a result thereof that the feature data of the person set as the tracing target has been received, the target data selector 30 outputs a tracing instruction to the feature data storage 24.

The feature data distributor 29 reads out the feature data of the person set as the target by the tracing instruction from the feature data DB 24a, and transports it to a partner registered in advance. The destination information of the destination to which the feature data is to be transported is recorded in the distribution destination database (DB) 29a in a form such as an IP address.

Note that each of the processing functions of the target data selector 30 and the personal feature data storage 31 shown in FIG. 18 is realized by executing, after a program stored in the HDD 240 in FIG. 3 is loaded into the RAM 230, arithmetic processing by the CPU 210 according to a process generated as the program progresses. That is, the HDD 240 stores a target data selection program and a personal feature data management program.

The personal feature data DB 31a shown in FIG. 18 is stored in a storage area provided in, for example, the HDD 240 in FIG. 3. Next, a working effect in the above configuration will be described.

### Mode in which Feature Data is Distributed to each Camera via the Image Processing Apparatus 200

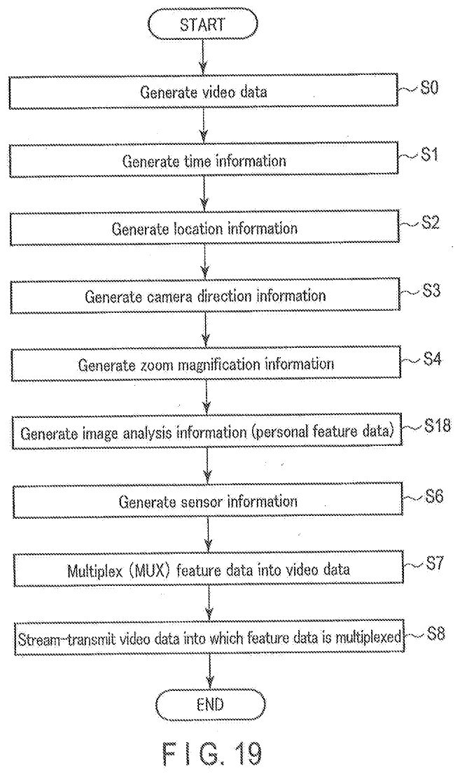

FIG. 19 is a flowchart showing an example of a processing procedure of the cameras C1 to Cn in the second embodiment. In FIG. 19, the portions common to FIG. 14 are denoted with the same reference signs, and only different portions will be described herein. After generating the zoom magnification information (step S4), the camera C1 generates image analysis information as personal feature data (step S18). For example, the aforementioned Haar-Like feature value, HOG feature value, or Co-HOG feature value, etc. can be used as the personal feature data. The personal feature data is generated in each of the cameras C1 to Cn, and is individually sent to the image processing apparatus 200 via the communication network.

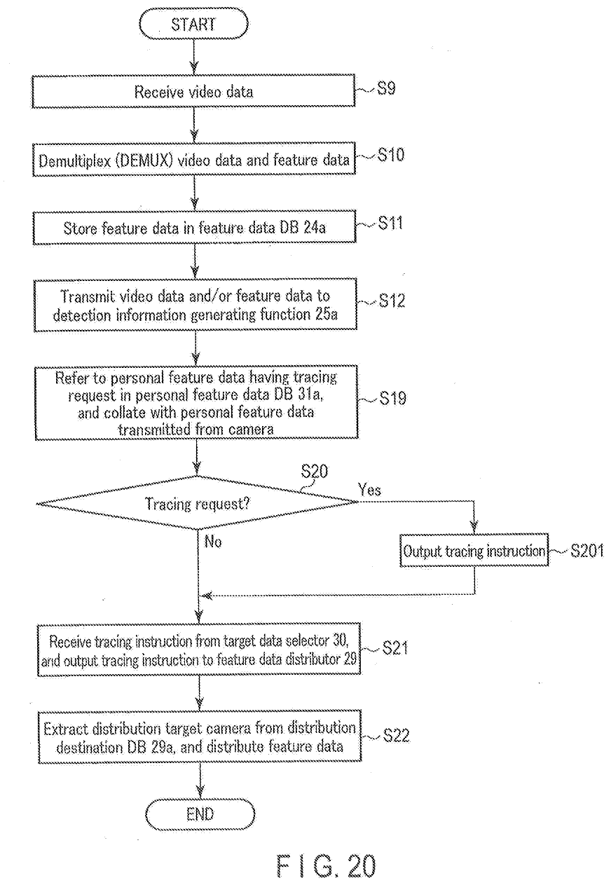

FIG. 20 is a flowchart showing an example of a processing procedure of the image processing apparatus 200 shown in FIG. 18. In FIG. 20, when the transport stream including the video data is received (step S9), the image processing apparatus 200 demultiplexes the video data and the feature data from the transport stream (step S10), and stores the feature data in the feature data DB 24a (step S11). The video data and/or the feature data is transmitted to the detection information generating function 25a (step S12). The personal feature data may be generated by the detection information generating function 25a.

Next, the image processing apparatus 200 refers to feature data of a person to be traced in the personal feature data DB 31a, and collates it with the personal feature data received from the cameras C1 to Cn (step S19). As a result, if there is a tracing request for the personal feature data received from the cameras C1 to Cn (Yes in step S20), the target data selector 30 outputs a tracing instruction (step S201).

When receiving the tracing instruction from the target data selector 30, the feature data storage 24 issues a tracing instruction to the feature data distributor 29 (step S21). Then, the feature data distributor 29 extracts a distribution target camera from the distribution destination DB 29a, and distributes the feature data (step S22).

According to the above procedure, the feature data can be mutually exchanged among the plurality of cameras C1 to Cn via the image processing apparatus 200. For example, an application can be realized in which if feature data of a suspicious person is acquired with a camera installed at a boarding gate of an international airport in country A, the feature data is transmitted in advance to cameras at destinations and waypoints of all aircrafts departing from the boarding gate. This makes it possible to accurately trace a movement locus of the suspicious person. Moreover, since the transport and processing of the feature data are performed via the image processing apparatus 200, it is possible to fully enjoy the processing capabilities of the image processing apparatus 200 and the cloud 100.

### Mode in which Cameras Mutually Distribute Feature Data

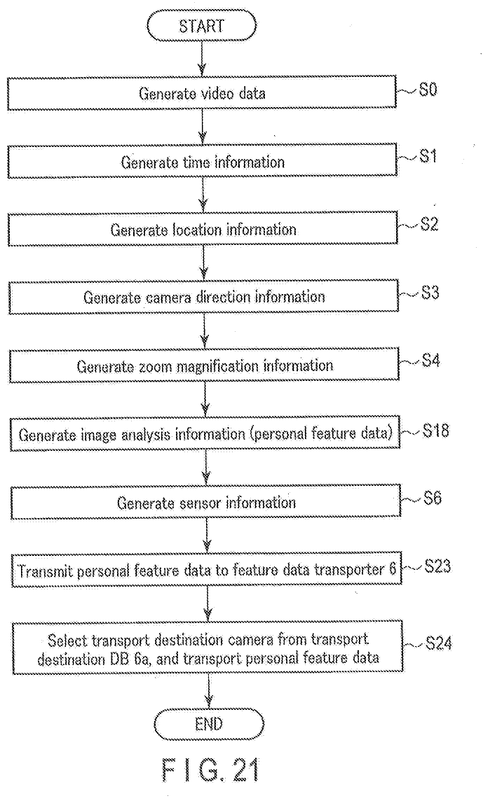

FIG. 21 is a flowchart showing another example of a processing procedure of the cameras C1 to Cn shown in FIG. 16. In FIG. 21, the portions common to FIG. 19 are denoted with the same reference signs, and only different portions will be described herein. After generating the sensor information (step S6), the camera C1 transmits the personal feature data to the feature data transporter 6 (step S23). The feature data transporter 6 selects a transport target camera from the transport destination DB 6a, and transports the feature data (step S24).

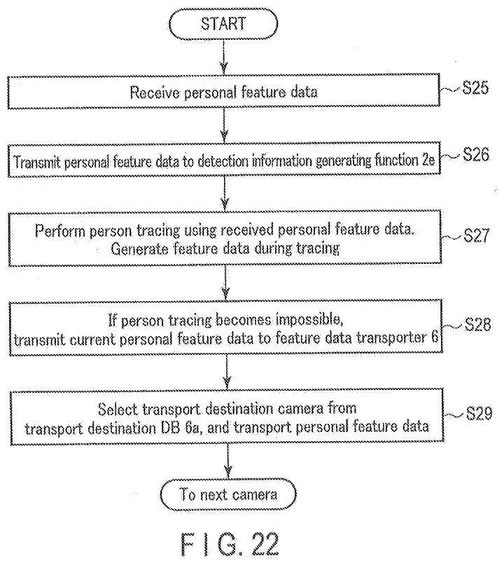

FIG. 22 is a flowchart, showing another example of a processing procedure of the cameras C1 to Cn in the second embodiment. Herein, the camera C6 will be mainly described. For example, when the personal feature data from the camera C1 is received (step S25), the camera C6 transmits the personal feature data to the detection information generating function 2e (step S26). The camera C6 performs person tracing using the personal feature data received from the camera C1, and also continues to generate the feature data based on the video signal during that time (step S27).

If person tracing becomes impossible such as in the case where the person to be traced is lost from the field of view, the camera C6 transmits the personal feature data generated during the tracing process to the feature data transporter 6 (step S28). Then, the camera C6 selects a transport target camera from the transport destination DB 6a, and transports the personal feature data (step S29). Then, the person to be traced is captured by the transport destination camera, and the person tracking is continued in the same manner.

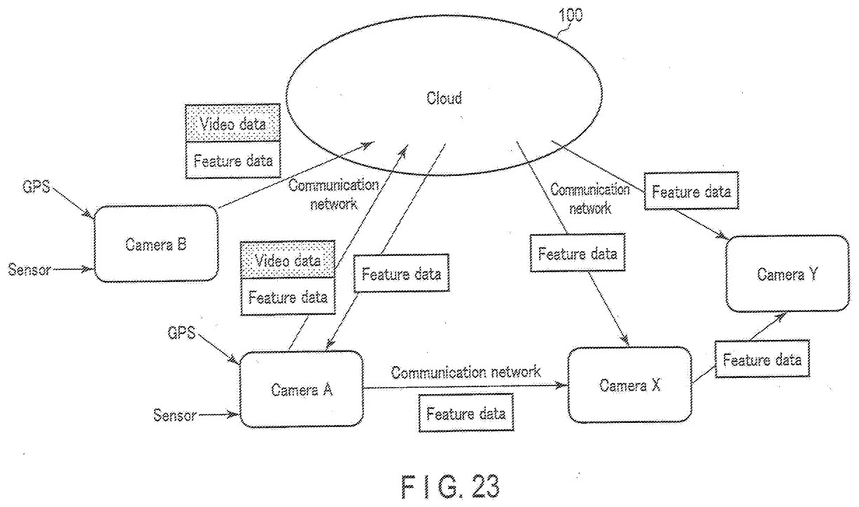

FIG. 23 is a diagram showing an example of a data flow related to person tracking in a surveillance camera system according to the embodiment. In FIG. 23, it is supposed that cameras A, B, X, and Y are related schematically.

The cameras A and B each multiplex video data and feature data into a transport stream, and transmit them to the cloud 100. The feature data transmitted from the camera B is transported to, for example, each of the cameras A, X, and Y via the image processing apparatus 200 of the cloud 100. As such, there is a route for transporting feature data of a person to a plurality of cameras via the image processing apparatus 200.

On the other hand, there is also a route for transporting feature data directly from the camera A to the camera X via a communication network. This feature data is further sent to the camera Y via the camera X. Feature data to be transported to the next camera is selected at each camera, and only data to be transported is sent out to a communication network. Unnecessary feature data may be discarded in a course of transport, and important feature data related to a suspicious person may pass through a number of cameras and be reused by respective cameras.

As described above, in the second embodiment, personal feature data related to person tracking is individually generated In the cameras C1 to Cn, and is synchronously multiplexed into video data and transported to the image processing apparatus 200. Thereby, a video signal and feature data can be synchronized and transported, and the image processing apparatus 200 can obtain the feature data synchronized with the video signal.

Furthermore, in the second embodiment, the feature data generated by each camera is converted into, for example, an IP packet, and directly transported to another camera. Therefore, the feature data can be exchanged among the cameras C1 to Cn without using the resources of the image processing apparatus 200. Thereby, a load of the cloud 100 can be moved to an edge side (camera, device side), with the resultant effect, that a load for analyzing the video data or a network load for transporting the feature data can be reduced.

### Third Embodiment

### Switchover of a Video of a Camera Having Multiple Imaging Units

A platform for linking a plurality of smart cameras with a cloud computing system (cloud) and using video data as big data is being developed. For example, the use of video data for fixed-point observation for disaster prevention, monitoring of traffic, monitoring of infrastructure such as roads and bridges, person searches or person tracking, tracing of suspicious persons, etc. has been considered.

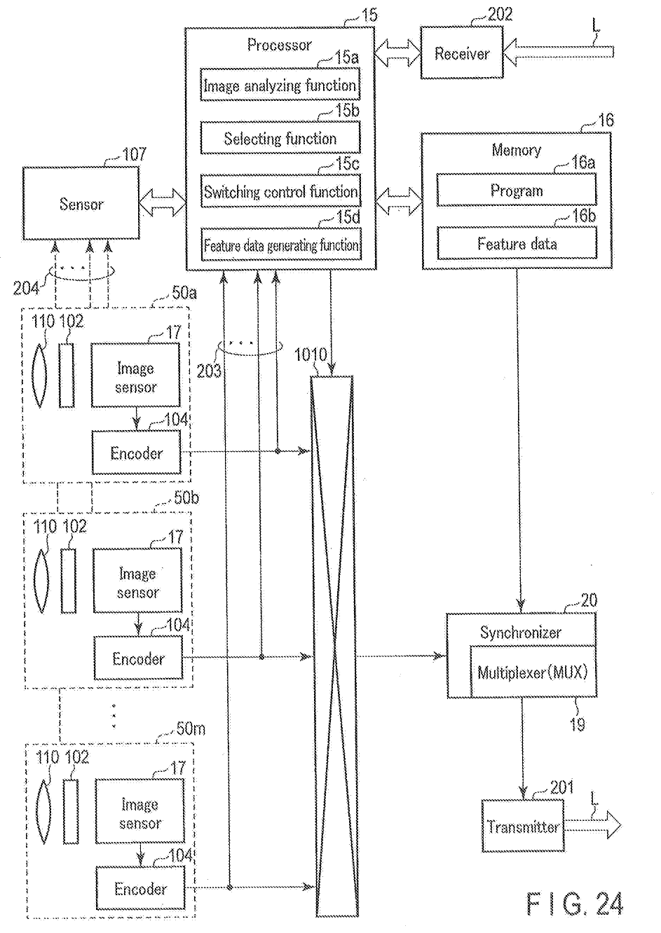

FIG. 24 is a block diagram showing a third example of the camera C1 shown in FIG. 1. The cameras C2 to Cn have the same configuration. The camera C1 includes a plurality of imaging units 50a to 50m, a switch 1010, the processor 15, the memory 16, a sensor 107, a transmitter 201, a receiver 202, a synchronizer 20, and a multiplexer (MUX) 19.

The imaging units 50a to 50m capture videos within respective fields of view, and individually generate video data. The imaging units 50a to 50m each include, for example, a lens 110, a collimator 102, the image sensor 17, and an encoder 104. An image within the field of view of the lens 110 is formed on the image sensor 17 through the lens 110 and the collimator 102. The image sensor 17 is an image sensor such as a CMOS (complementary metal oxide semiconductor) sensor, and generates, for example, a video signal having a frame rate of 30 frames per second. The encoder 104 encodes a video signal output from the image sensor 17 to generate video data. The video data from the imaging units 50a to 50m are transported to the switch 1010 and the processor 15 via an internal bus 203.

Imaging wavelength bands of the imaging units 50a to 50m may be different from one another. For example, imaging wavelength bands such as visible light, near-infrared light, far-infrared light, and ultraviolet light may be individually assigned to each of the imaging units 50a to 50m. That is, the camera C1 may be a multispectral camera.

The sensor 107 acquires, for example, parameter information such as a device type of the imaging units 50a to 50m, the number of pixels, a frame rate, sensitivity, a focal distance of the lens 110, a light, amount of the collimator 102, a field angle, absolute time information, camera direction information, zoom magnification information, and wavelength characteristics of the filter via a data bus 204, and transports them to the processor 15 and the memory 16. The sensor 107 has a positioning function by, for example, GPS (Global Positioning System), and acquires location information of the camera C1 and time information by a positioning process using a positioning signal received from a GPS satellite. The sensor 107 transports the acquired location information and time information to the processor 15 and the memory 16. The location information is important in a case where a camera itself moves, for example, a case where the camera is installed on a cellular phone or a car. The sensor 107 includes, for example, sensors such as a temperature sensor, a humidity sensor, and an acceleration sensor, and acquires, through these sensors, information on an environment where the camera C1 is installed as sensor information. The sensor 107 transports the acquired sensor information to the processor 15 and the memory 16.

The switch 1010 selectively sends out video data output from any one of the imaging units 50a to 50m to the synchronizer 20. The video data to be selected from the imaging units 50a to 50m is determined by the processor 15.

The synchronizer 20 synchronizes the video data from the switch 1010 with feature data including a feature value generated from this video data. The feature value is generated by the processor 15 based on the video data. The feature data is generated by the processor 15 based on the feature value, and the parameter information, sensor information, location information, time information that are transported from the sensor 107, etc.

The video data precedes the feature data in terms of time, for example, by the time required for generating the feature data based on the video data. The synchronizer 20 temporarily stores the video data in a buffer memory for the preceding time. The synchronizer 20 synchronizes the video data and the feature data by reading the video data from the buffer memory in sync with the timing at which the feature data is actually created. The synchronized video data and feature data are send to the multiplexer 19.

The multiplexer 19 multiplexes the video data and the feature data synchronized with the video data into, for example, a transport stream of an MPBG-2 (Moving Picture Experts Group-2) system.

The transmitter 201 transmits the transport stream into which the video data and the feature data are multiplexed to the image processing apparatus 200 of the cloud 100 via the line L.

The receiver 202 acquires data transmitted from the cloud 100 or the image processing apparatus 200 via the line L. The data transmitted from the image processing apparatus 200 includes, for example, a message regarding image processing in the image processing apparatus 200. The message includes, for example, information indicating a type of image processing method and priority video parameters (such as a contrast value and a signal-to-noise ratio). The acquired data is transported to the processor 15 and the memory 16.

The memory 16 is, for example, a semiconductor memory such as a synchronous dynamic RAM (SDRAM), or a non-volatile memory such as an erasable programmable ROM (EPROM) and an electrically erasable programmable ROM. The memory 16 stores a program 16a for causing the processor 15 to execute various functions according to the embodiment, and feature data 16b.

The processor 15 controls an operation of the camera C1 based on the program stored in the memory 16. The processor 15 is, for example, an LSI (Large Scale Integration) that includes a multi-core CPU (Central Processing Unit) and is tuned so that image processing can be performed at high speed. The processor 15 can be configured by an PPGA (Field Programmable Gate Array), etc. Note that the processor 15 may be configured using an MPU (Micro Processing Unit) instead of the CPU.

The processor 15 includes an image analyzing function 15a, a selecting function 15b, a switching control function 15c, and a feature data generating function 15d as processing functions according to the embodiment. In the image analyzing function 15a, the selecting function 15b, the switching control function 15c, and the feature data generating function 15d can be understood as processes generated via execution, after the program 16a stored in the memory 16 is loaded into a register of the processor 15, of arithmetic processing by the processor 15 as the program progresses. That is, the program 16a includes an image analysis program, a selection program, a switchover program, and a feature data generation program.

The image analyzing function 15a performs image analysis and video analysis on the video stream transported from the imaging units 50a to 50m. Thereby, the image analyzing function 15a generates a feature value for each video stream transported from the imaging units 50a to 50m. In the present embodiment, a feature value is used as, for example, an index indicating a feature of a video and an index indicating a characteristic of an image. The feature value includes, for example, information for identifying the properties of video such as a visible light video, an infrared video, a far-infrared video, an ultraviolet video, a color video, or a monochrome video. More specifically, the feature value includes a Histograms of Oriented Gradients (HOG) feature value, contrast, resolution, an S/N ratio, a color tone, etc. A co-occurrence HOG (Co-HOG) feature value, a Haar-Like feature value, etc. are also known as feature values.

The selecting function 15b determines which video data, among that of the imaging units 50a to 50m, is suitable for transportation to the image processing apparatus 200 for the image processing being executed in the image processing apparatus 200. That is, the selecting function 15b selects an imaging unit that generates video data corresponding to the image processing of the image processing apparatus 200. Specifically, the selecting function 15b selects one of the imaging units 50a to 50m, for example, by using a predetermined evaluation value. The evaluation value represents a degree of correspondence of the video data to the image processing of the image processing apparatus 200, and is calculated based on the feature value calculated by the image analyzing function 15a.

For example, in a case where a contour extraction process is performed in the image processing apparatus 200, the selecting function 15b calculates an index representing whether a contour of a video is clear or unclear for each of the video stream transported from the imaging units 50a to 50m. This index can be expressed numerically in a range of 0 to 100, for example, based on the feature value of the video data, and the value is used as an evaluation value. When paying attention to the contour extraction process, a value of an imaging unit that outputs a high-contrast monochrome image is the highest evaluation value.

The selecting function 15b selects an imaging unit that generates video data having the highest evaluation value.

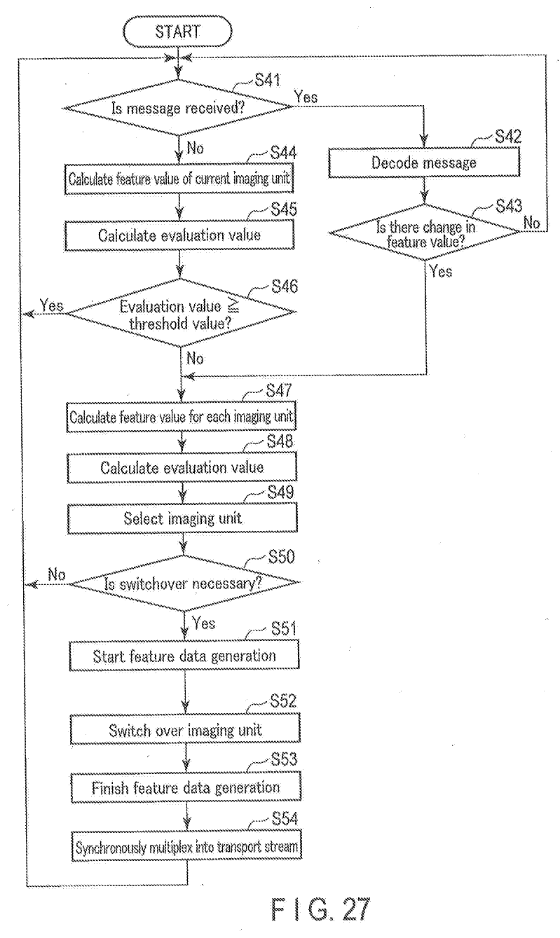

Frequent switching over of the imaging unit is not a preferable situation for the image processing apparatus 200. Accordingly, the selecting function 15b calculates only the evaluation value for the video data generated by the imaging unit currently in use, for example, unless a message indicating the change of image processing method, etc. is transmitted from the image processing apparatus 200. If the calculated evaluation value is equal to or greater than a predetermined threshold value, the selecting function 15b does not calculate an evaluation value for video data generated by another imaging unit. On the other hand, if the calculated evaluation value is less than the predetermined threshold value, the selecting function 15b calculates an evaluation value for the video data generated by another imaging unit. Details will be described with reference to the flowchart of FIG. 27.

For example, in a case where the image processing employed in the image processing apparatus 200 allows frequent switchover of the imaging unit, the selecting function 15b may calculate an evaluation value of each of the imaging units, for example, at a constant cycle (every minute, every 10 minutes, every hour, etc.). Thereby, it is possible to flexibly cope with changes in the environment (weather, etc.).

Every time another imaging unit is selected by the selecting function 15b, the switching control function 15c and the switch 1010 switch over to and output video data from the selected imaging unit by synchronizing frame phases of the respective video data from the imaging units. That is, the switching control function 15c and the switch 1010 each function as a switching unit. If the photography environment changes greatly with the passage of time or the request of the image processing apparatus 200 changes, an imaging unit different from the one currently in use is selected. Then, the switching control function 15c synchronizes a frame phase of the video data from the imaging unit selected so far with a frame phase of the video data from the newly selected imaging unit in accordance with a synchronization signal of the internal bus 203. Specifically, by matching a phase of a start symbol of a frame of the video data before switchover and a phase of a start symbol of a frame of the video data after switchover to a synchronization signal from the outside, the frame phases of the respective video data are synchronized. When the frame synchronization is complete, the switching control function 15c switches over the switch 1010, and sends the video data from the selected imaging unit to the synchronizer 20.

The feature data generating function 15d generates feature data of the video data from the imaging unit selected by the selecting function 15b. Specifically, the feature data generating function 15d generates the feature data of the video data from the imaging unit selected by the selecting function 15b based on the feature value generated by the image analyzing function 15a, and the sensor information, location information, and time information transported from the sensor 107. The generated feature data is temporarily stored in the memory 16 (feature data 16b), and sent to the synchronizer 20. Note that after the connection is switched over by the switching control function 15c, the feature data generating function 15d may be configured to stop generation of feature data when a period of time sufficient for the image processing of the image processing apparatus 200 to follow has sent.

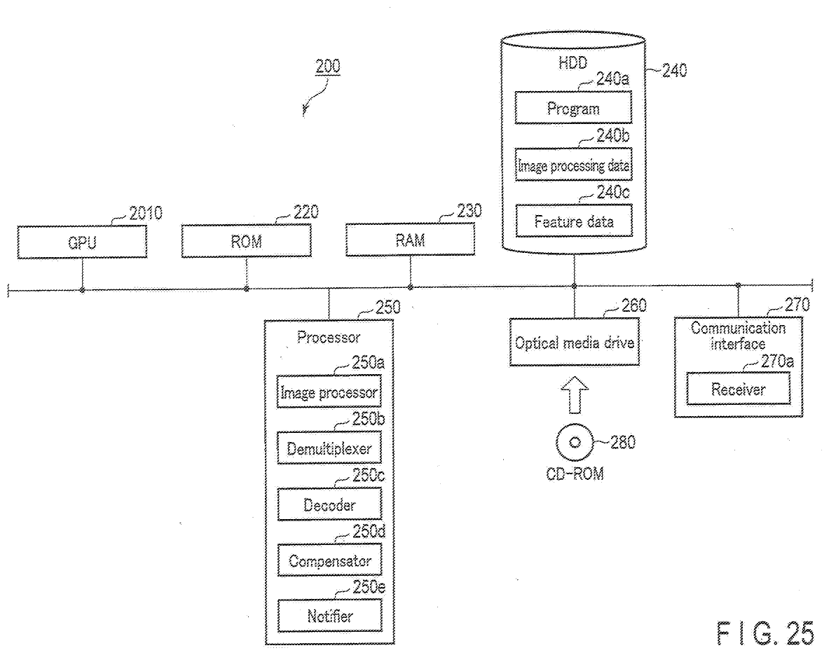

FIG. 25 is a block diagram showing a third example of the image processing apparatus 200. The image processing apparatus 200 is a computer including a processor 250 such as a CPU or an MPU. The image processing apparatus 200 includes the ROM (Read Only Memory) 220, the RAM (Random Access Memory) 230, the hard disk drive (HDD) 240, the optical media drive 260, and the communication interface 270. Furthermore, a GPU (Graphics Processing Unit) 2010, which is a processor with enhanced functions for image processing, may be provided. The GPU can execute arithmetic processing such as a product-sum operation, a convolution operation, and a 3D (three-dimensional) reconstruction at high speed.

The ROM 220 stores basic programs such as BIOS (Basic input Output System) and UEFI (Unified Extensible Firmware Interface), various setting data, etc. The RAM 230 temporarily stores programs and data loaded from the HDD 240. The HDD 240 stores a program 240a executed by the processor 250, image processing data 240b, and feature data 240c.

The optical media drive 260 reads digital data recorded on a recording medium such as a CD-ROM 280. Various programs executed by the image processing apparatus 200 are recorded on, for example, the CD-ROM 280, and distributed. The program stored in the CD-ROM 280 is read by the optical media drive 260, and installed in the HDD 240. The latest program can be downloaded from the cloud 100 via the communication interface 270 to update the already-installed program.

The communication interface 270 is connected to the cloud 100, and communicates with the cameras C1 to Cn and other servers and databases of the cloud 100. The various programs executed by the image processing apparatus 200 may be, for example, downloaded from the cloud 100 via the communication interface 270, and installed in the HDD 240.

The communication interface 270 includes a receiver 270a. The receiver 270a receives a transport stream including video data from the cameras C1 to Cn via the communication network, of the cloud 100.

The processor 250 executes an OS (Operating System) and various programs.

The processor 250 includes an image processor 250a, a demultiplexer 250b, a decoder 250c, a compensator 250d, and a notifier 250e, as processing functions according to the embodiment. The image processor 250a, the demultiplexer 250b, the decoder 250c, the compensator 250d, and the notifier 250e can be understood as processes generated by loading the program 240a stored in the HDD 240 into a register of the processor 250, and then executing arithmetic processing by the processor 250 as the program progresses. That is, the program 240a includes an image processing program, a demultiplexing program, a decoding program, a compensation program, and a notification program.

The image processor 250a performs image processing on video data included in the received transport stream or a video decoded from this video data to obtain image processing data such as point cloud data and person tracing data. This image processing data is stored in the HDD 240 as the image processing data 240b.

The demultiplexer 250b demultiplexes the above video data and feature data from the received transport stream. The demultiplexed feature data is stored in the HDD 240 as the feature data 240c.

The decoder 250c decodes the demultiplexed video data and reproduces the video.

The compensator 250d compensates for continuity of the reproduced video based on the demultiplexed feature data. That is, the compensator 250d performs a color tone conversion process of each pixel so that videos before and after switchover of the imaging unit gradually change based on the feature data (sensor information/parameter information). For example, the compensator 250d performs processing so that the color tone of each pixel of the received video gradually changes during a total of 20 seconds, i.e. 10 seconds before switchover and 10 seconds after switchover. Such processing is known as “morphing.” It is preferable that a period of time for changing the video is longer than a period of time necessary for the image processing function of the image processing apparatus 200 to follow the switchover of the imaging unit.

An image frame that has undergone the processing by the compensator 250d is send to the image processor 250a. The image processor 250a can perform image processing on the compensated video even if the received video data includes a deficit.

The notifier 250e notifies the cameras C1 to Cn of a message including information related to the image processing of the image processor 250a. For example, information indicating whether or not to prioritize the type of the image processing method and the contrast of the video, or the signal-to-noise ratio of the video, etc. is notified to the cameras C1 to Cn by the message.

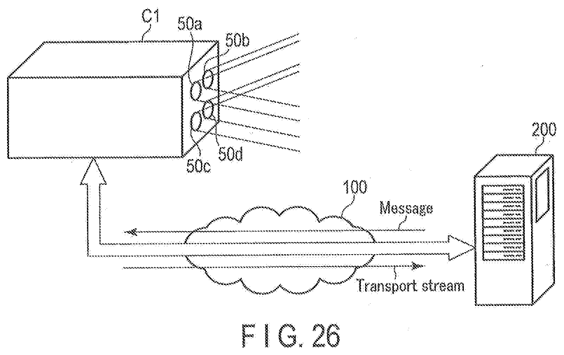

FIG. 26 is a diagram showing an example of information exchanged between the camera C1 and the image processing apparatus 200. The camera C1 multiplexes and sends video data generated by a selected imaging unit and feature data about this video data into a transport stream. The image processing apparatus 200 sends a message regarding image processing to the camera C1 via the cloud 100 as necessary. The camera C1 receiving the message selects an imaging unit corresponding to information described in the message from the imaging units 50a to 50d. Then, the camera C1 multiplexes and sends video data generated by the selected imaging unit and feature data about this video data into a transport stream.

FIG. 27 is a flowchart showing an example of a processing procedure of the cameras C1 to Cn according to the third embodiment. Herein, description will be made mainly with reference to the camera C1, but the cameras C2 to Cn operate in the same manner.

In FIG. 27, the camera C1 waits for a notification of a message from the image processing apparatus 200 (step S41). If a message is received (Yes in step S41), the camera C1 decodes a content thereof (step S42). The message received here includes, for example, information indicating the type of image processing method or priority video parameters (a contrast value, a signal-to-noise ratio, etc.). The camera C1 determines whether or not a feature value to be calculated, and that is recognized by decoding, needs to be changed from a feature value that is a current calculation target (step S43).

If there is no change in the feature value to be calculated (No in step S43), the processing procedure returns to step S41, and the camera C1 waits for a message notification from the image processing apparatus 200. If it is determined in step S43 that there is a change in the feature value (Yes), the processing procedure reaches step S47.

On the other hand, if a message is not received in step S41 (No), the camera C1 calculates the feature value that is the current calculation target for the video data from the imaging unit (current imaging unit) being selected at that moment (step S44), and calculates an evaluation value based on this feature value (step S45).

Next, the camera C1 compares the calculated evaluation value with a predetermined threshold value (step S46). If the evaluation value is equal to or greater than the threshold value (Yes), the evaluation value of the current imaging unit is sufficiently high, so switchover of the imaging unit is skipped, and the processing procedure returns to step S41. If the evaluation value is less than the threshold value in step S46 (No), the camera C1 calculates the feature value that is the current calculation target for each of the video data generated by the imaging units 50a to 50m (step S47).

Here, advancement of the processing procedure from step S46 to step S47 means that the image processing apparatus 200 has not requested to change the feature value to be calculated. On the other hand, when the processing procedure reaches from step S43 to step S47, the image processing apparatus 200 has requested to change the feature value to be calculated.

Next, the camera C1 calculates an evaluation value based on the calculated feature value (step S48). Based on this evaluation value, the camera C1 selects an imaging unit with the highest evaluation value among the imaging units 50a to 50m (step S49). If the current imaging unit and the selected imaging unit are the same (No in step S50), switchover of the imaging unit is skipped and the processing procedure returns to step S41.

If the current imaging unit is different from the selected imaging unit, the camera C1 determines that switchover of the imaging unit is necessary (Yes in step S50), and starts generation of feature data related to a video of the imaging unit that is the switchover destination (step S51). Next, the camera C1 synchronizes frames of video signals between the newly-selected imaging unit and the currently-selected imaging unit, and executes switchover of the imaging unit (step S52). Then, when a predetermined period of time including the point of the frame switchover has elapsed, the generation of the feature data ends (step S53). The feature data generated during that time together with the video data is, for example, synchronously multiplexed into a transport stream as shown in FIG. 7 (step S54), and transmitted to the image processing apparatus 200.

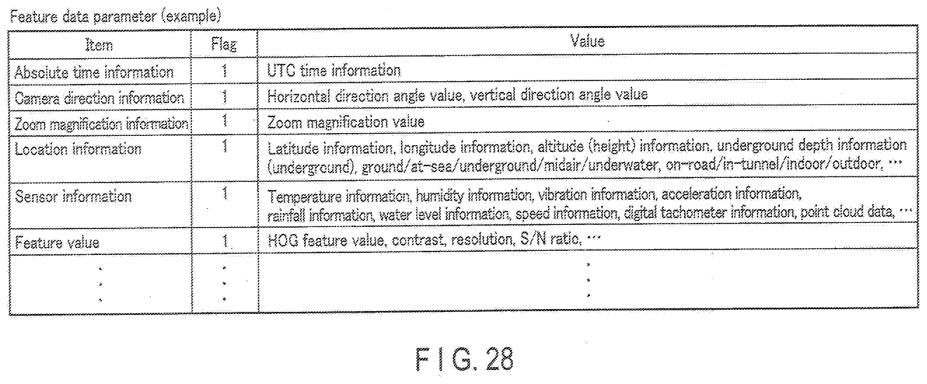

FIG. 28 is a diagram showing another example of parameters of feature data generated by the camera C1. In FIG. 28, the feature data parameters include items such as parameter information such as absolute time information, camera direction information, and zoom magnification information, location information, sensor information, and feature values. The sensor information can include, for example, temperature information, humidity information, digital tachometer information (such as an in-vehicle camera), point cloud data of a structure, etc.

As described above, in the third embodiment, in the camera having a plurality of imaging units, the imaging unit most suitable for the image processing of the image processing apparatus 200 is determined on the camera side. That is, in the camera, processing similar to the image processing of the image processing apparatus 200 is performed on the video from each imaging unit, and an imaging unit with the highest score (evaluation value) is selected.

In the third embodiment, when switching over a video of a camera having a plurality of imaging units, a feature value over a period of time sufficient to eliminate discontinuity in the image processing in the image processing apparatus 200 is calculated on the camera side, synchronously multiplexed into video data, and transported to the image processing apparatus 200.

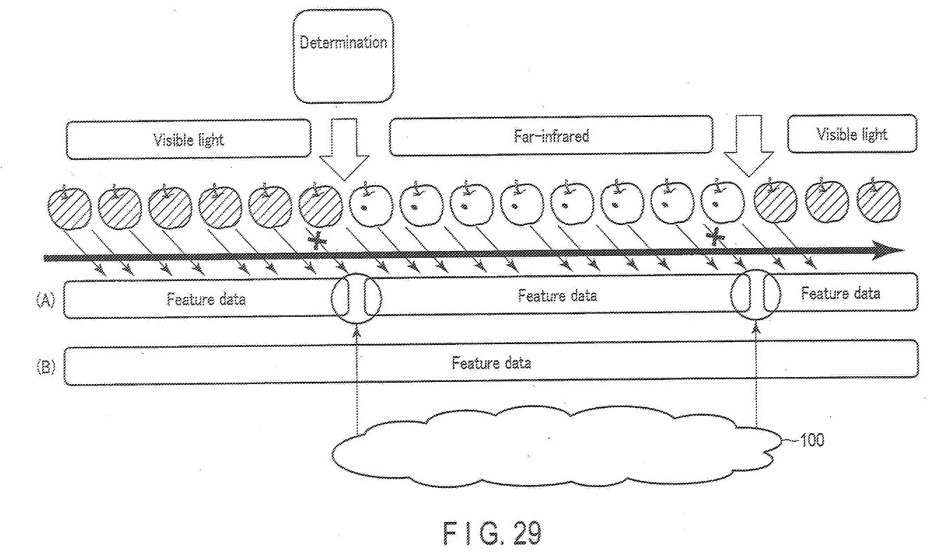

In the existing remote monitoring system, if a color tone difference between videos (imaging units) is large, feature data becomes discontinuous as shown in FIG. 29 (a) as an imaging unit of a camera is switched over, and image processing may be reset on the image processing apparatus 200 side. Such a tendency is particularly strong in a hybrid camera system using different types of cameras.

In contrast, in the third embodiment, in a camera that generates a video stream, an imaging unit that generates a video most suitable for image processing of the image processing apparatus 200 is selected by the selecting function 15b. When the selected imaging unit changes, video data frames are synchronized between the former and latter imaging units, and the video data is switched over. Then, the video data and its feature data (sensor information, parameter information, determination result, etc.) are synchronously multiplexed into a transport frame, and sent to the image processing apparatus 200.

This makes it possible to send, at the time of synchronous switchover of a plurality of cameras, feature data from a camera to the image processing apparatus 200 via the cloud, as shown in FIG. 29 (b). Thereby, the feature data is transported to the image processing apparatus 200 without a break, and continuity of the feature data can be compensated for in the image processing apparatus 200.

Furthermore, based on the feature data acquired via the cloud, the compensator 250d compensates for continuity of a video sent in synchronization with this feature data. That is, the compensator 250d compensates for the continuity of the videos before and after the switchover of the imaging unit using the feature data during image processing. As a result, the image processing apparatus 200 can perform image processing based on the compensated video data.

In this way, a camera most suitable for the image processing apparatus 200 can be selected to switch over the video. In addition, since the video data and the feature data associated with this video data are synchronously multiplexed into the same transport stream, a time series of the video would not be deviated from that of the feature data resulting from analysis of the video. Accordingly, it is possible to maintain the continuity of the image processing in the image processing apparatus 200. Therefore, it is possible to achieve both the economics of sharing a plurality of camera videos on a single transport line and maintaining processing accuracy while continuously performing image processing on the receiving side.

That is, according to the third embodiment, it is possible to provide a smart camera, an image processing apparatus, and a data communication method, capable of maintaining continuity of image processing before and after video switchover.

### Example of Application to a Multi-View Camera System

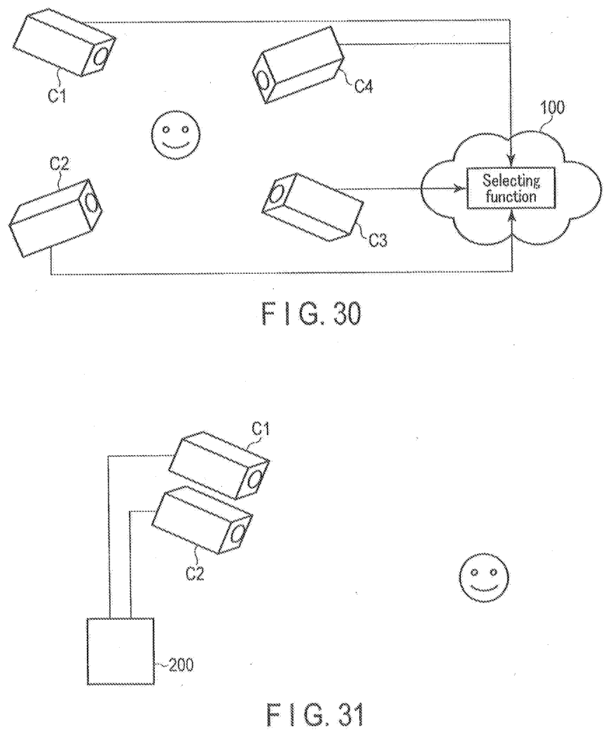

FIG. 30 is a diagram showing an example of a multi-view camera system. The discussion according to the third embodiment also holds true for the multi-view camera system. In the case shown in FIG. 30, for example, the functions of the selecting function 15b and the switching control function 15c may be implemented as services of the cloud 100.

### Example of Application to an Array Camera System

FIG. 31 is a diagram showing an example of a so-called array camera system including a plurality of cameras arranged in an array. For example, there is an array camera system in which the camera C1 is a visible light camera, the camera C2 is an infrared camera, and both the cameras C1 and C2 observe a common subject. In this type of system, the same discussion as in the third embodiment can be held by implementing the selecting function 15b, the switching control function 15c, and the switch 1010 shown in FIG. 24 on the image processing apparatus 200. That is, when the cameras C1 and C2 are switched according to image processing of the image processing apparatus 200, if feature data necessary for the image processing is synchronously multiplexed into video data and transported, continuity of the image processing in the image processing apparatus 200 can be compensated for.

The present invention is not limited to the above-described embodiments. For example, feature data multiplexed into a transport stream may include at least one of the following information such as: absolute time information, camera direction information, zoom magnification information, location information, detection information (sensor information, image analysis information, etc.), and a feature value, according to system requirements.

In addition, the data stored in the feature data DB of FIG. 13 may be a set having coordinates as elements, and the data stored in the point cloud data DB 28a of the point cloud data storage 28 may be data representing a past state of the set. In this case, the time series change detector 26 detects a change of a surface reconstructed from a coordinate group included in each set with respect to time. This time change of the surface is sent as deformation information to the deformation information storage 27, and stored in the deformation data DB 27a.

For example, sensor information may include at least one of temperature information, humidity information, vibration information, acceleration information, rainfall information, water level information, speed information, digital tachometer information, and point cloud data, or information such as a device type of an imaging unit, the number of pixels, a frame rate, sensitivity, a focal distance of a lens, a light, amount, and a field angle, according to system requirements.

In the third embodiment, the same discussion as the above also holds true not only for a multispectral camera including a plurality of cameras, but also for a camera of a type that obtains a plurality of videos with a monocular camera by combining different wavelength cut filters in a single imaging unit.

In the third embodiment, feature data is generated when switching over the imaging unit and multiplexed into a video stream. In addition, the feature data may be constantly calculated and multiplexed into the video stream when necessary (when a switchover of the imaging unit occurs).

In the third embodiment, it has been described that the image analyzing function 15a analyzes a video for each of the imaging units 50a to 50m, and generates a feature value of the video for each of the imaging units 50a to 50m. There is not only a feature value defined for a video but also a feature value calculated for an image. Therefore, it is possible to configure the calculation of a feature value of an image by the image analyzing function 15a to execute various processing based on the feature value of the image.

Furthermore, the function of the image analyzing function 15a in the third embodiment may be individually implemented in each of the imaging units 50a to 50m. Video data of captured videos and feature values of the videos can thereby be collectively output from the imaging units 50a to 50m. The selecting function may obtain evaluation values using the feature values accompanying the video data, and select any one of the imaging units 50a to 50m. By shifting the analysis processing to the imaging units 50a to 50m in this way, the resources of the processor 15 can be saved.

In general, a cloud computing system is roughly classified into SaaS (Software as a Service) that provides an application as a service, PaaS (Platform as a Service) that provides a platform for operating the application as a service, IaaS (Infrastructure as a Service) that provides resources such as a high-speed computing function and a large-capacity storage as services. The cloud 100 shown in FIG. 1 can be applied to any category of system.

The term “processor” used in connection with a computer can be understood as, for example, a circuit such as CPU, GPU, ASIC (Application Specific Integrated Circuit), SPLD (Simple Programmable Logic Device), CPLD (Complex Programmable Logic Device), or FPGA.

By reading out and executing a program stored in a memory, a processor realizes a specific function based on the program. A program can be directly incorporated in a circuit of a processor instead of a memory. In this case, the processor realizes a function of the program by reading out and executing the program incorporated in the circuit.

Although several embodiments of the present invention have been described, these embodiments are presented by way of example and are not intended to limit the scope of the invention. These novel embodiments can be implemented in various other forms, and various omissions, replacements, and changes can be made without departing from the scope of the invention. These embodiments and modifications thereof are included in the scope and gist of the invention, and are included in the invention described in the claims and the equivalents thereof.

1. A smart camera comprising:
an image sensor configured to output a video signal;
an encoder implemented by one or more, hardware processors and configured to encode the video signal to generate video data;
a feature data generating function implemented by one or more hardware processors and configured to generate feature data of the video signal;
a synchronizer implemented by one or more hardware processors and configured to synchronize the generated feature data with the video data;
a multiplexer implemented by one or more hardware processors and configured to multiplex the video data and the feature data synchronized with the video data into a transport stream; and
a transmitter configured to transmit the transport stream to a communication network.

2. The smart camera according to claim 1, further comprising an analyzer implemented by one or more hardware processors and configured to analyze the video signal and generate image analysis information based on the video signal,
wherein the synchronizer synchronizes feature data including the image analysis information with the video data.

3. The smart camera according to claim 1, wherein the synchronizer synchronizes the feature data with a time stamp of an image frame of the video signal.

4. The smart camera according to claim 1, wherein the multiplexer multiplexes feature data in a preset period into the transport stream.

5. The smart camera according to claim 1, wherein the feature data includes at least one of capturing time information of the video signal, directivity direction information of the image sensor, tilt angle information of the image sensor, zoom magnification information of the image sensor, and location information of the image sensor.

6. The smart camera according to claim 1, wherein the feature data is point cloud data including coordinates, and attribute information of a point corresponding to the coordinates.

7. The smart camera according to claim 1, further comprising a transporter configured to transport the feature data to another smart camera via the communication network.

8. The smart camera according to claim 7, further comprising a transport destination database in which destination information of a destination to which the feature data is to be transported is recorded in advance,
wherein the transporter transports the feature data to destination information recorded in the transport destination database.

9. A smart camera capable of communicating with an image processing apparatus, comprising:
a plurality of imaging units each configured to generate video data;
a selecting function implemented by one or more hardware processors and configured to select an imaging unit that generates video data corresponding to image processing in the image processing apparatus from the plurality of imaging units;
a switch implemented by one or more hardware processors and configured to switch over to and output the video data from the selected imaging unit by synchronizing mutual frame phases, each time another imaging unit is selected by the selecting function;
a feature data generating function implemented by one or more hardware processors and configured to generate feature data of a video from the selected imaging unit over a predetermined period including a point of the switchover and outputting;
a synchronizer configured to synchronize the video data switched over to and output with the feature data;
a multiplexer configured to multiplex the synchronized video data and feature data into a transport stream; and
a transmitter configured to transmit the transport stream to the image processing apparatus.

10. The smart camera according to claim 9, further comprising an image analyzing function implemented by one or more hardware processors and configured to analyze a video for each of the imaging units and generate a feature value of the video for each of the imaging units,
wherein the selecting function selects an imaging unit that generates video data corresponding to image processing in the image processing apparatus based on the feature value of the video for each of the imaging units.

11. The smart camera according to claim 10, wherein the selecting function calculates an evaluation value indicating a degree corresponding to the image processing in the image processing apparatus for each of the imaging units based on the feature value, and
wherein the imaging unit that generates the video data corresponding to the image processing in the image processing apparatus is selected based on the evaluation value.

12. The smart camera according to claim 11, wherein the selecting function selects an imaging unit different from a selected imaging unit if an evaluation value of the selected imaging unit is less than a predetermined threshold value.

13. The smart camera according to claim 9, further comprising a receiver configured to receive a message including information on the image processing from the image processing apparatus,
wherein the selecting function selects the imaging unit according to the information included in the message.

14. The smart camera according to claim 9, wherein each of the plurality of imaging units is individually assigned with an imaging wavelength band.

15. The smart camera according to claim 14, wherein the plurality of imaging units include an infrared camera and a visible light camera.

16. The smart camera according to claim 9, wherein the feature data includes at least one of sensor information of the imaging unit and parameter information of the video.

17. The smart camera according to claim 16, wherein the sensor information includes at least, one of a device type, a number of pixels, a frame rate, sensitivity, a focal distance of a lens, a light amount, and a field angle.

18. The smart camera according to claim 17, wherein the parameter information includes at least one of a color tone of the video and a luminance histogram.

19. An image processing apparatus comprising:
a receiver configured to receive a transport stream including video data and feature data of the video data, the feature data being synchronously multiplexed into the video data;
a demultiplexer implemented by one or more hardware processors and configured to demultiplex the video data and the feature data from the received transport stream; and
a storage configured to store the demultiplexed feature data.

20. The image processing apparatus according to claim 19, further comprising:
a detector configured to detect a time-series change of data related to infrastructure from the demultiplexed feature data; and
a storage configured to store deformation information related to the infrastructure based on the time-series change of the data.

21. The image processing apparatus according to claim 20, wherein the data related to the infrastructure is point cloud data including coordinates and attribute information of a point corresponding to the coordinates.

22. The image processing apparatus according to claim 19, further comprising:
a storage configured to store the demultiplexed feature data;
a personal feature database configured to record personal feature data indicating a feature of a person; and
a selecting function implemented by one or more hardware processors and configured to collate the demultiplexed feature data with the personal feature data in the personal feature database and based on a result thereof, select feature data of a person set as a tracing target from the storage.

23. The image processing apparatus according to claim 19, further comprising:
a transport destination database in which destination information of a destination to which the feature data is to be transported is recorded in advance; and
a transporter configured to transport the feature data to the destination information recorded in the transport destination database.

24. The image processing apparatus according to claim 19, wherein the receiver receives from a smart camera including a plurality of imaging units, and
wherein the demultiplexer demultiplexes the video data and the feature data synchronized with the video data from the received transport stream, the image processing apparatus further comprising:
a decoder implemented by one or more hardware processors and configured to decode the video data and reproduce a video;
a compensator implemented by one or more hardware processors and configured to compensate for continuity of the reproduced video based on the demultiplexed feature data; and
an image processor implemented by one or more hardware processors and configured to perform image processing based on the compensated video.

25. The image processing apparatus according to claim 24, further comprising a notifier implemented by one or more hardware processors and configured to notify the smart camera of a message including information related to the image processing.

26. The image processing apparatus according to claim 25, wherein the message includes any one of information indicating that a contrast of the video is prioritized and information indicating that a signal-to-noise ratio of the video is prioritized.

27. A data communication method applicable to a smart camera including an image sensor configured to output a video signal and a processor, comprising:
encoding, by the processor, the video signal to generate video data;
generating, by the processor, feature data of the video signal;
synchronizing, by the processor, the generated feature data with the video data
multiplexing, by the processor, the video data and the feature data synchronized with the video data into a transport stream; and
transmitting, by the processor, the transport stream to a communication network.

28. The data communication method according to claim 27, further comprising:
analyzing, by the processor, the video signal to generate image analysis information based on the video signal,
wherein the processor synchronizes feature data including the image analysis information with the video data.

29. The data communication method according to claim 27, wherein the processor synchronizes the feature data with a time stamp of an image frame of the video signal.

30. The data communication method according to claim 27, wherein the processor multiplexes feature data in a preset period into the transport stream.

31. The data communication method according to claim 27, wherein the feature data includes at least one of capturing time information of the video signal, directivity direction information of the image sensor, tilt angle information of the image sensor, zoom magnification information of the image sensor, and location information of the image sensor.

32. The data communication method according to claim 27, further comprising transporting, by the processor, the feature data to another smart camera via the communication network.

33. The data communication method according to claim 32, wherein the processor transports the feature data to destination information of a destination to which the feature data is to be transported, the destination information being recorded in a transport destination database in advance.

34. A data communication method applicable to a smart camera including a plurality of imaging units each generating video data and a processor, comprising:
selecting, by the processor, an imaging unit that generates video data corresponding to image processing in an image processing apparatus;
each time another imaging unit is selected, switching over to and outputting, by the processor, the video data from the selected imaging unit by synchronizing mutual frame phases;
generating, by the processor, feature data of a video from the selected imaging unit over a predetermined period including a point of the switchover and outputting;
synchronizing, by the processor, the switched-over to and output video data and the feature data;
multiplexing, by the processor, the synchronized video data and feature data into a transport stream; and
transmitting, by the processor, the transport stream to the image processing apparatus.

35. The data communication method according to claim 34, further comprising analyzing, by the processor, a video for each of the imaging units and generating a feature value of the video for each of the imaging units,
wherein, in the selecting, the processor selects an imaging unit that generates video data corresponding to image processing in the image processing apparatus, based on the feature value of the video for each of the imaging units.

36. The data communication method according to claim 35, wherein the selecting includes:
calculating, by the processor, an evaluation value indicating a degree corresponding to image processing in the image processing apparatus for each of the imaging units based on the feature value; and
selecting, by the processor, an imaging unit that generates video data corresponding to the image processing in the image processing apparatus based on the evaluation value.

37. The data communication method according to claim 36, wherein, in the selecting, the processor selects an imaging unit different from a selected imaging unit if an evaluation value of the selected imaging unit is less than a predetermined threshold value.

38. The data communication method according to claim 34, further comprising:
receiving, by the processor, a message including information on the image processing from the image processing apparatus; and
selecting, by the processor, the imaging unit according to the information included in the message.

39. The data communication method according to claim 34, wherein the feature data includes at least one of sensor information of the imaging unit and parameter information of the video.

40. The data communication method according to claim 39, wherein the sensor information includes at least one of a device type, a number of pixels, a frame rate, sensitivity, a focal distance of a lens, a light amount, and a field angle.
